(19) United States
(12) Patent Application Publication
(10) Pub. No.: US 2014/0143524 A1
(43) Pub. Date: May 22, 2014

(54) INFORMATION PROCESSING APPARATUS, INFORMATION PROCESSING APPARATUS CONTROL METHOD, AND A COMPUTER-READABLE STORAGE MEDIUM STORING A CONTROL PROGRAM FOR CONTROLLING AN INFORMATION PROCESSING APPARATUS

(71) Applicant: FUJITSU LIMITED, Kawasaki-shi (JP)

(72) Inventor: Tsuguchika Tabaru, Machida (JP)

(73) Assignee: FUJITSU LIMITED, Kawasaki-shi (JP)

(21) Appl. No.: 14/033,983

(22) Filed: Sep. 23, 2013

(30) Foreign Application Priority Data
Nov. 20, 2012 (JP) 2012-254129

(51) Int. Cl. G06F 9/30

(52) U.S. Cl. CPC G06F 9/3001
USPC 712/221

(57) ABSTRACT

An information processing apparatus includes a first arithmetic processing apparatus, a second arithmetic processing apparatus, and a control unit that controls the first arithmetic apparatus and the second arithmetic apparatus, wherein the control unit causes each of the first arithmetic processing apparatus and the second arithmetic processing apparatus to execute a first data processing common to the first and the second arithmetic processing apparatuses, and the control unit causes the second arithmetic processing apparatus to stop the first data processing when the first data processing executed by the first arithmetic processing apparatus is completed earlier than the first data processing executed by the second arithmetic processing apparatus.

### CROSS-REFERENCE TO RELATED APPLICATION

This application is based upon and claims the benefit of priority from the prior Japanese Patent Application No. 2012-254129 filed on Nov. 20, 2012, the entire contents of which are incorporated herein by reference.

### FIELD

The present disclosure relates to an information processing apparatus, a control method and a control program thereof.

### BACKGROUND

An accelerator such as a GPU (Graphics Processing Unit) is able to operate dozens to several thousands of arithmetic processing units or arithmetic cores in parallel to process large amounts of data using a clock frequency lower than that of a CPU (Central Processing Unit). A program which operates such type of an accelerator may be designed using a program environment similar to that for the CPU. For example, a plurality of threads are distributed into the CPU and the GPU to be executed, such that the efficiency of data processing may be improved. See, for example, Japanese Laid-Open Patent Publication No. 2011-523140 and Japanese Laid-Open Patent Publication No. 2011-523141.

### SUMMARY

According to one aspect of the present disclosure, an information processing apparatus includes a first arithmetic processing apparatus, a second arithmetic processing apparatus, and a control unit that controls the first arithmetic apparatus and the second arithmetic apparatus, wherein the control unit causes each of the first arithmetic processing apparatus and the second arithmetic processing apparatus to execute a first data processing common to the first and the second arithmetic processing apparatuses, and the control unit causes the second arithmetic processing apparatus to stop the first data processing when the first data processing executed by the first arithmetic processing apparatus is completed earlier than the first data processing executed by the second arithmetic processing apparatus.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary information processing apparatus according to an embodiment.

FIG. 2 illustrates an exemplary operation of the information processing apparatus illustrated in FIG. 1.

FIG. 3 illustrates an exemplary information processing apparatus according to another embodiment.

FIG. 4 illustrates an exemplary system including the information processing apparatus according to another embodiment.

FIG. 5 illustrates an exemplary operation of the information processing apparatus illustrated in FIG. 4.

FIG. 6 illustrates another exemplary operation of the information processing apparatus illustrated in FIG. 4.

FIG. 7 illustrates an exemplary operation of the information processing apparatus according to another embodiment.

FIG. 8 illustrates operations continued from the operations illustrated in FIG. 7.

FIG. 9 illustrates another exemplary operation of the information processing apparatus which executes the processes illustrated in FIG. 7.

FIG. 10 illustrates operations continued from the operations illustrated in FIG. 9.

FIG. 11 illustrates an exemplary operation of a processing thread which has started a data processing illustrated in FIG. 7.

FIG. 12 illustrates an exemplary operation of a management thread after instructing the start of the data processing illustrated in FIG. 7.

FIG. 13 illustrates an exemplary operation of each thread of a GPU which has started the data processing illustrated in FIG. 7.

FIG. 14 illustrates an exemplary operation in an information processing apparatus according to another embodiment.

FIG. 15 illustrates operations continued from the operations illustrated in FIG. 14.

FIG. 16 illustrates another exemplary operation of the information processing apparatus which executes the processes illustrated in FIG. 14.

FIG. 17 illustrates operations subsequent to the operations illustrated in FIG. 16.

FIG. 18 illustrates another exemplary operation of the information processing apparatus which executes the processes illustrated in FIG. 14.

FIG. 19 illustrates another exemplary operation of the information processing apparatus which executes the processes illustrated in FIG. 14.

FIG. 20 illustrates a scheme for distributing and executing one-tenth of a data processing.

FIG. 21 illustrates an exemplary operation of the information processing apparatus according to another embodiment.

### DESCRIPTION OF EMBODIMENTS

When a CPU and a GPU execute a plurality of threads in parallel, for example, the degree of parallelism of the threads (the number of threads that can be executed simultaneously) may be analyzed such that the CPU executes a process having a lower degree of parallelism and the GPU executes a process having a higher degree of parallelism. However, the degree of parallelism may be changed depending on the characteristics of input data and thus, it is difficult to appropriately allocate the threads to the CPU and the GPU.

The present disclosure intends to execute a data processing without analyzing a data processing time of an arithmetic processing apparatus in advance such that the data processing may be conducted with a high speed.

In an information processing apparatus, a control method and a control program thereof according to one aspect of the present disclosure, a control unit of the information processing apparatus which includes a first arithmetic processing apparatus, a second arithmetic processing apparatus, and the control unit which controls the first arithmetic processing apparatus and the second arithmetic processing apparatus causes the first arithmetic processing apparatus and the second arithmetic processing apparatus to execute a first data processing common for the first arithmetic processing apparatus and the second arithmetic processing apparatus, respectively, and causes the second arithmetic processing apparatus to stop the first data processing executed by the second arithmetic processing apparatus when the first data processing executed by the first arithmetic processing apparatus is completed earlier than the first data processing executed by the second arithmetic processing apparatus.

It is possible to execute a data processing with a high speed as compared to conventional techniques without analyzing a processing time of the first and the second arithmetic processing apparatuses in advance by causing the first arithmetic processing apparatus and the second arithmetic processing apparatus to execute the first data processing which is common for the first and second arithmetic processing apparatuses and using a result of the first data processing which is completed first.

Hereinbelow, embodiments will be described with reference to accompanying drawings.

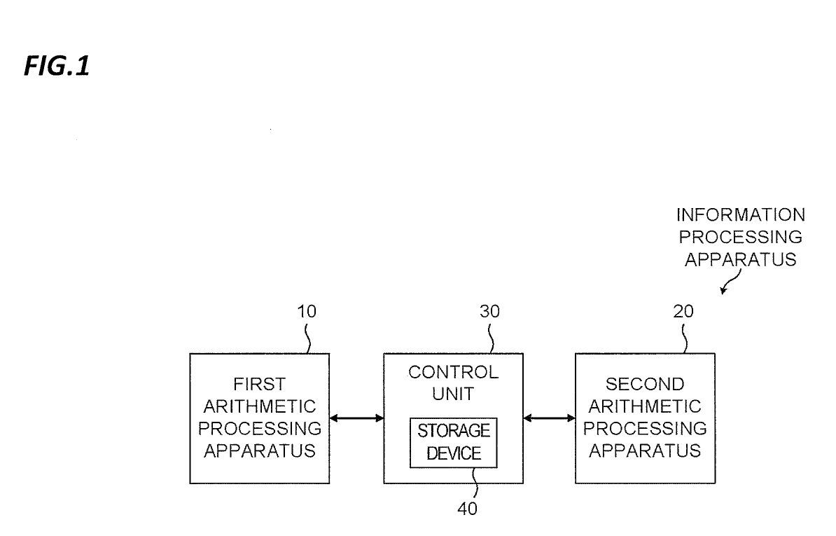

FIG. 1 illustrates an example of an information processing apparatus according to an embodiment. The information processing apparatus includes a first arithmetic processing apparatus 10, a second arithmetic processing apparatus 20, and a control unit 30 which controls the first arithmetic processing apparatus 10 and the second arithmetic processing apparatus 20. For example, the first arithmetic processing apparatus 10 is a processor, such as a CPU, which executes the first data processing by a sequential processing based on a program. Also, the second arithmetic processing apparatus 20 may be an accelerator, such as the GPU, which executes the second data processing by a parallel processing based on a program. In the meantime, the first arithmetic processing apparatus 10 may be another processor which executes the data processing by a sequential processing, and the second arithmetic processing apparatus 20 may be another accelerator which executes the data processing by a parallel processing. The GPU may be a GPGPU (General Purpose Graphics Processing Unit) capable of executing a general data processing.

The control unit 30 controls the operations of the first arithmetic processing apparatus 10 and the second arithmetic processing apparatus 20 implementing a control method of the information processing apparatus. For example, the control unit 30 executes the control program stored in the storage device 40 to control the first arithmetic processing apparatus 10 and the second arithmetic processing apparatus 20. The control unit 30 may be included in one of the first arithmetic processing apparatus 10 and the second arithmetic processing apparatus 20. When the control unit 30 is included in the first arithmetic processing apparatus 10, the first arithmetic processing apparatus 10 may execute the control program and the program for data processing of the first arithmetic processing apparatus 10 in a time sharing method. However, when the first arithmetic processing apparatus 10 has a function for executing a plurality of processes simultaneously similar to a multi-core CPU, the program for the data processing and the control program may be executed simultaneously. When the control unit 30 is included in the second arithmetic processing apparatus 20, the second arithmetic processing apparatus 20 executes the control program and the program for a data processing of the second arithmetic processing apparatus 20 in parallel.

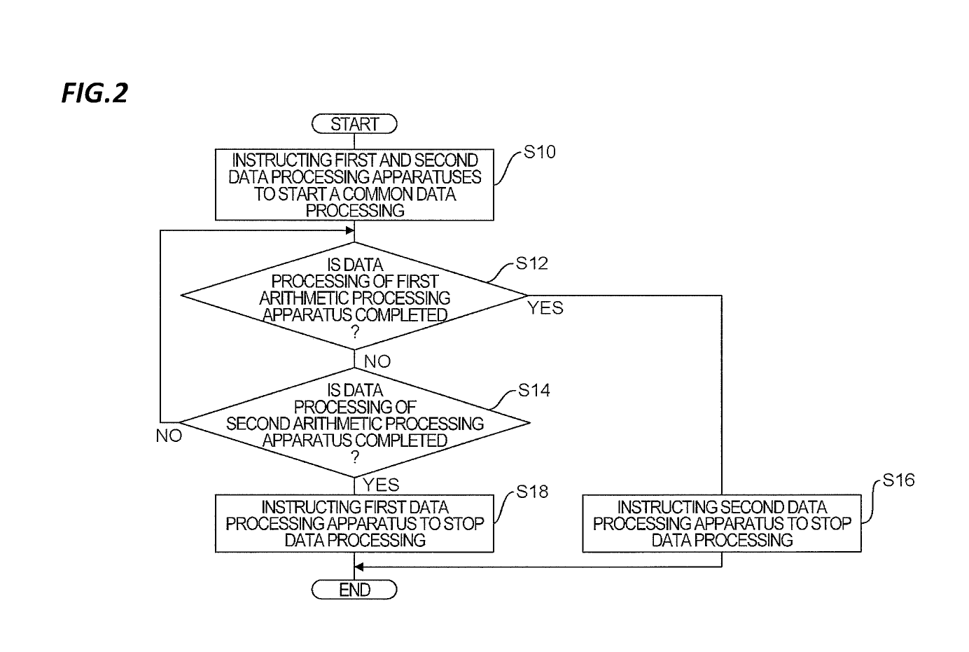

FIG. 2 illustrates an exemplary operation of the information processing apparatus illustrated in FIG. 1. The control unit 30 may execute a program stored in the storage device 40 to implement a flow illustrated in FIG. 2. That is, FIG. 2 illustrates the contents of the control program of the information processing apparatus and the contents of a control method of the information processing apparatus.

At step S10, the control unit 30 instructs each of the first arithmetic processing apparatus 10 and the second data processing apparatus 20 to start a data processing common for the first arithmetic processing apparatus 10 and the second arithmetic processing apparatus 20. The first arithmetic processing apparatus 10 and the second data processing apparatus (20) each start the execution of the common data processing based on the instruction from the control unit 30. Here, the first arithmetic processing apparatus 10 and the second arithmetic processing apparatus 20 each execute the data processing using a common input data, and the results obtained by the data processing are the same with each other.

Subsequently, at step S12, it is determined whether the control unit 30 has received a notification from the first arithmetic processing apparatus 10 that the data processing is completed. When it is determined that the control unit 30 has received the notification from the first arithmetic processing apparatus 10 that the data processing is completed, the process proceeds to step S16. However, when the control unit 30 has not received the notification from the first arithmetic processing apparatus 10, the process proceeds to step S14.

At step S14, it is determined whether the control unit 30 has received a notification from the second arithmetic processing apparatus 20 that the data processing is completed. When it is determined that the control unit 30 has received the notification from the second arithmetic processing apparatus 20 that the data processing is completed, the process proceeds to step S18. When, however, the control unit 30 has not received the notification from the second arithmetic processing apparatus 20 that the data processing is completed, the process goes back to step S12. In the meantime, the sequence of steps S12 and S14 may be reversed.

When the data processing by the first arithmetic processing apparatus 10 is completed earlier than the data processing by the second arithmetic processing apparatus 20, the control unit 30 instructs the second arithmetic processing apparatus 20 to stop the data processing at step S16. The second arithmetic processing apparatus 20 stops the data processing based on the instruction from the control unit 30.

When the data processing by the second arithmetic processing apparatus 20 is completed earlier than the data processing by the first arithmetic processing apparatus 10, the control unit 30 instructs the second arithmetic processing apparatus 20 to stop the data processing at step S18. The first arithmetic processing apparatus 10 stops the data processing based on the instruction from the control unit 30.

Thereafter, for example, the control unit 30 may be configured such that the result obtained by the data processing may be transferred from an arithmetic processing apparatus which has completed the data processing first (e.g., the first arithmetic processing apparatus 10) to another arithmetic processing apparatus (e.g., the second arithmetic processing apparatus 20). In this case, the control unit 30 causes each of the first arithmetic processing apparatus 10 and the second arithmetic processing apparatus 20 to execute the next common data processing using the result obtained by the data processing. Also, the next common data processings are sequentially executed using the result obtained by the data processing of the arithmetic processing apparatus which has completed the next data processing first.

As described above, in this embodiment, the information processing apparatus may obtain the result of the data processing which has been completed first among the common data processing executed in parallel by the first and second arithmetic processing apparatuses 10, 20. Accordingly, the result of the arithmetic processing apparatus which has completed the data processing first may actually be used in a data processing where it is unable to determine which one of the sequential processing and the parallel processing has been completed first, and thus, the throughput of the information processing apparatus may be improved. That is, as compared to conventional techniques, the data processing times of the first and second arithmetic processing apparatuses 10, 20 are not analyzed in advance and thus, the data processing may be executed with a high speed.

When an accelerator such as the GPU is utilized, an overhead caused by, for example, the data transferring between the CPU and the accelerator may be generated. Further, when the degree of parallelism is changed depending on input data, large amounts of datasets may need to be prepared, and the data processing times of the CPU and the accelerator may need to be analyzed in advance to search a boundary condition at which the processing times are reversed. Also, the data processing may be executed using the arithmetic processing apparatus having a smaller processing time determined by the analysis. Further, when the CPU or the accelerator is replaced with another CPU or another accelerator having different performance capability, respectively, the performance parameters may be changed and the processing time for the data processing may be changed accordingly.

Even in this case, analyzing of the processing time or tuning of the program may not be performed in this embodiment. That is, a preprocessing in which both the data processing time required for executing performed by the sequential processing and the data processing time required for executing performed by the parallel processing are roughly calculated and the data processing time having a smaller processing time, is not performed. Since the data processing which has a smaller data processing time is selectively utilized, the flow illustrated in FIG. 2 may be executed even when parameters or load conditions are changed during the execution of the data processing.

As a result, the processing efficiency of the information processing apparatus may be improved without changing the program of the first arithmetic processing apparatus 10 and the program of the second arithmetic processing apparatus 20 which execute the data processing by, for example, a tuning. In other words, even when the computation capability is changed because of the change of input data and thus, the length of the data processing time of the first and the second arithmetic processing apparatuses 10, 20 is reversed, the result of the data processing which has been completed first may be utilized without changing the program.

Further, even when it is not known which one of the first and the second arithmetic processing apparatuses 10, 20 has a smaller data processing time, an increase of the data processing time may be suppressed to increase the opportunity for utilizing the accelerator such as the second arithmetic processing apparatus 20. For example, the opportunity for utilizing the accelerator may be increased in a compiler or a translator which converts a program into another program.

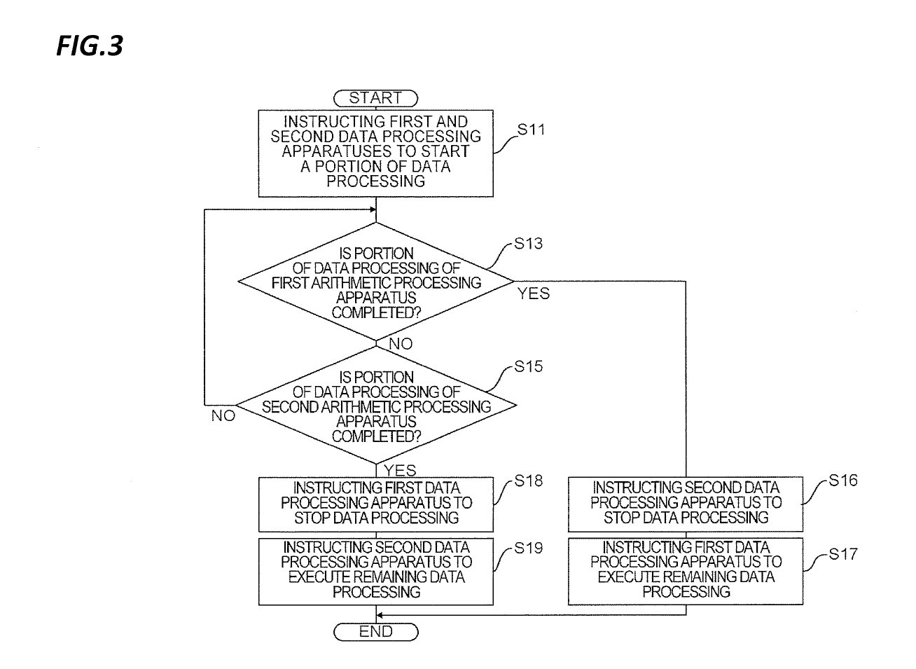

FIG. 3 illustrates an exemplary operation of an information processing apparatus according to another embodiment. Same reference numerals are given to the same process or similar process as the process illustrated in FIG. 2, and the details thereof will be omitted. For example, the information processing apparatus, as illustrated in FIG. 1, includes the first arithmetic processing apparatus 10 and the second arithmetic processing apparatus 20, and the control unit 30 which controls the first arithmetic processing apparatus 10 and the second arithmetic processing apparatus 20. The control unit 30 executes the program stored in the storage device 40 to implement the flow illustrated in FIG. 3. That is, FIG. 3 illustrates the contents of the control program of the information processing apparatus and the contents of the control method of the information processing apparatus.

In this embodiment, the control unit 30 controls the first and the second arithmetic processing apparatuses 10, 20 to execute a portion of the data processing and determines whether which one of the first and the second arithmetic processing apparatuses 10, 20 is able to execute the data processing with a high speed. The processes of steps S16, S18 are the same or similar to those of steps S16, S18. Further, steps S11, S13, S15 are executed on behalf of steps S10, S12, S14 illustrated in FIG. 2.

At step S11, the control unit 30 instructs each of the first arithmetic processing apparatus 10 and the second data processing apparatus (20) to start a portion of the data processing common for the first and second arithmetic processing apparatuses. The first arithmetic processing apparatus 10 and the second data processing apparatus (20) each start the execution of the portion of the data processing based on the instruction from the control unit 30. Here, the first arithmetic processing apparatus 10 and the second arithmetic processing apparatus 20 each execute the portion of the data processing using common input data, the and results obtained by the portion of the data processing are the same with each other.

At step S13, it is determined whether the control unit 30 has received a notification from the first arithmetic processing apparatus 10 that the portion of the data processing is completed. When it is determined that the control unit 30 has received the notification from the first arithmetic processing apparatus 10 that the portion of the data processing is completed, the process proceeds to step S16. When, however, it is determined that the control unit 30 has not received the notification from the first arithmetic processing apparatus 10 that the portion of the data processing is completed, the process proceeds to step S15.

At step S15, it is determined whether the control unit 30 has received a notification from the second arithmetic processing apparatus 20 that the portion of the data processing is completed. When it is determined that the control unit 30 has received the notification from the second arithmetic processing apparatus 20 that the portion of the data processing is completed, the process proceeds to step S18. When, however, it is determined that the control unit 30 has not received the notification from the second arithmetic processing apparatus 20, the process returns to step S13. In the meantime, the sequence of step S13 and step S15 may be reversed with each other.

After executing step S16, the control unit 30 instructs the first data processing apparatus 10 to execute the remaining portion of the data processing at step S17. After executing step S18, the control unit 30 instructs the second data processing apparatus 20 to execute the remaining portion of the data processing at step S19.

Thereafter, for example, the control unit 30 may be configured such that the result obtained by the portion of the data processing may be transferred from an arithmetic processing apparatus which has been instructed to execute the remaining portion of the data processing (e.g., the first arithmetic processing apparatus 10) to another arithmetic processing apparatus (e.g., the second arithmetic processing apparatus 20). In this case, the control unit 30 causes each of the first arithmetic processing apparatus 10 and the second arithmetic processing apparatus 20 to execute a portion of the next common data processing using the result obtained by the remaining portion of the data processing. Also, the control unit 30 controls the arithmetic processing apparatus which has completed the portion of the data processing first to execute the remaining portion of the data processing. Further, the next common data processes are sequentially executed using the result obtained by the remaining portion of the data processing.

As described above, also in this embodiment, similar to the embodiment illustrated in FIG. 1 and FIG. 2, the result of the data processing which has been completed first may actually be used in the data processing where it is unable to determine which one of the sequential processing and the parallel processing has been completed first, and thus, the processing efficiency of the information processing apparatus may be improved. That is, as compared to conventional techniques, the data processing may be executed with a high speed without analyzing the data processing times of the CPU 100 and the GPU 200 in advance.

Furthermore, a portion of the data processing is executed to determine which one of the sequential processing and the parallel processing is completed first and thus, a time period during which the first and the second arithmetic processing apparatuses 10, 20 execute the data processing in duplicate becomes shorter compared to the process of FIG. 2. The first and the second arithmetic processing apparatuses 10, 20 execute the common data processing and thus, the data processing executed by one of the first and the second arithmetic processing apparatuses 10, 20 becomes useless. In this embodiment, the efficiency of the processing may be improved by making the useless data processing at a minimum level. Further, it is possible to make the time period during which the data processing is executed in duplicate shorter and thus, the power consumption of the information processing apparatus may be reduced.

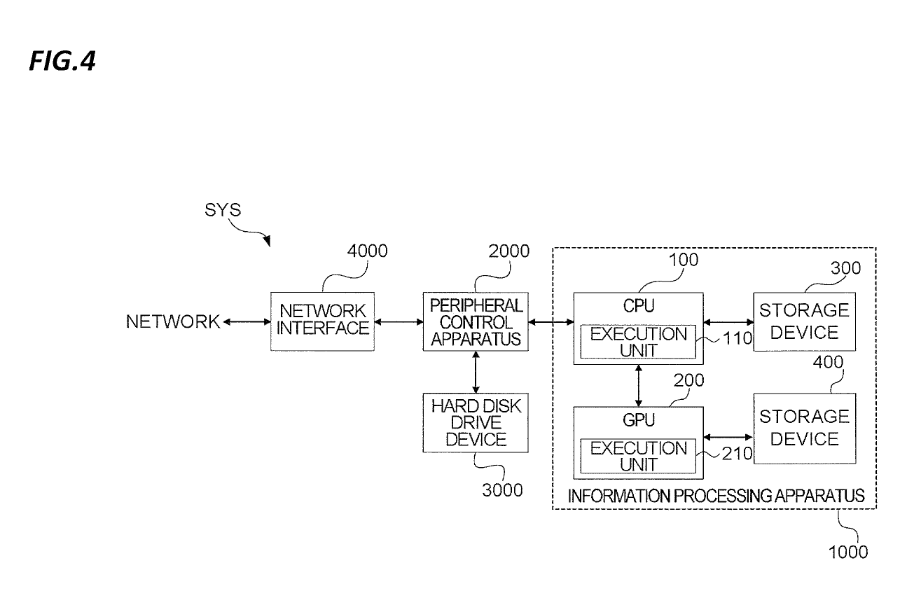

FIG. 4 illustrates an example of a system including the information processing apparatus according to another embodiment. The system SYS includes an information processing apparatus 1000, a peripheral control apparatus 2000, a hard disk drive device 3000 and a network interface 4000. For example, the system SYS may be a computer system such as a server. In the meantime, the configuration of the system SYS is not limited to the example of the configuration illustrated in FIG. 4.

The information processing apparatus 1000 includes a processor such as the CPU 100, an accelerator such as the GPU 200 and the storage devices 300, 400. The CPU 100 is an example of the first arithmetic processing apparatus and the GPU 200 is an example of the second arithmetic processing apparatus. The CPU 100 includes an execution unit 110 which executes the data processing and manages the data processing executed by the GPU 200. The GPU 200 includes an execution unit 210 which executes the data processing. The GPU may be a GPGPU (General Purpose Graphics Processing Unit) capable of executing general data processing.

The storage device 300 may include a data processing program executed by the execution unit 110, a management program which manages operations of the CPU 100 and the GPU 200, and a storage area in which data processed by the data processing program is stored. For example, the storage device 400 includes a data processing program executed by the execution unit 210 and a storage area in which data processed by the data processing program is stored. A data processing according to the data processing program executed by the execution unit 110 and a data processing according to the data processing program executed by the execution unit 210 are common for each other. The input data used in the data processings are the same with each other and the results obtained by the data processings are the same with each other. In the meantime, the storage device 300 may be installed within the CPU 100, and the storage device 400 may be installed within the GPU 200.

The storage device 300 may store an original program of the data processing program executed by each of the execution units 110, 210, and a compiler or a translator which generates the data processing program executed by each of the execution units 110, 210 from the original program. In this case, for example, the CPU 100 executes the compiler or the translator to generate the data processing program executed by the execution unit 110 from the original programs and stores the generated data processing program into the storage device 300. Further, the CPU 100 executes the compiler or the translator to generate the data processing program executed by the execution units 210 from the original programs and stores the generated data processing program into the storage device 400.

The peripheral control apparatus 2000 controls the operations of the hard disk drive device 3000 and the network interface 4000 based on the instruction from the CPU 100. For example, the hard disk drive device 3000 stores information delivered from a network and stores the information to be output to the network. The network interface 4000 controls an information exchange between the information processing apparatus 1000 and the network.

The data processing program executed by each of the execution units 110, 210 or the original program of the data processing program may be transferred from the network to the hard disk drive device 3000 or to the information processing apparatus 1000. Further, the peripheral control apparatus 2000 may be connected to an optical drive device. In this case, the original program of the data processing program that executed by each of the execution units 110, 210 is transferred to the hard disk drive device 3000 or the information processing apparatus 1000 through an optical disk installed on the optical drive device.

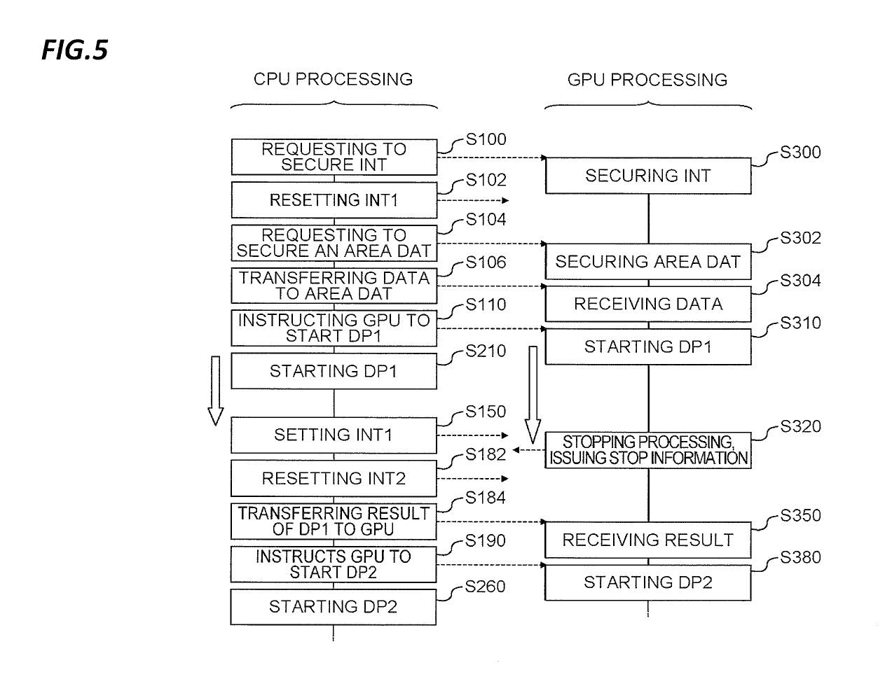

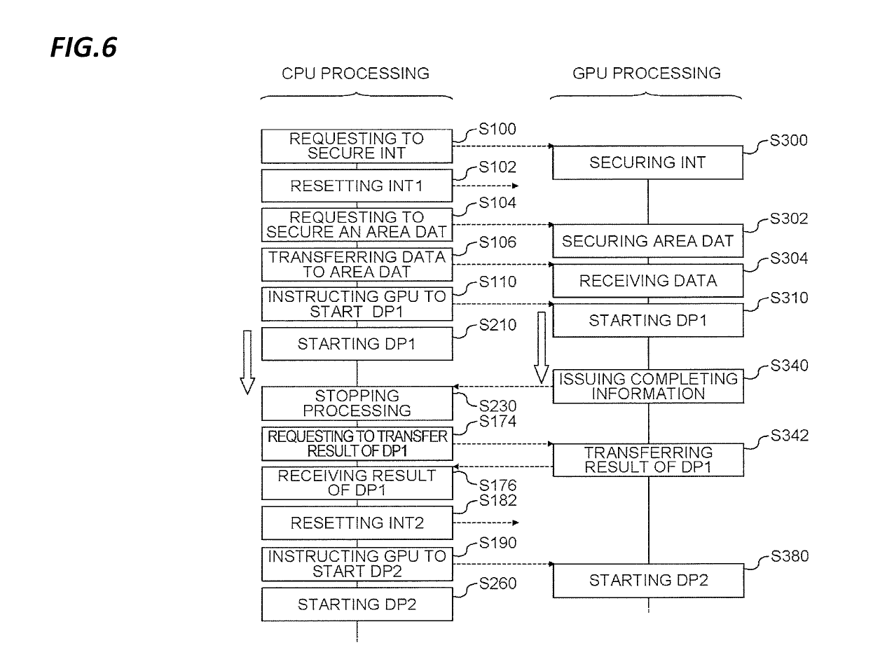

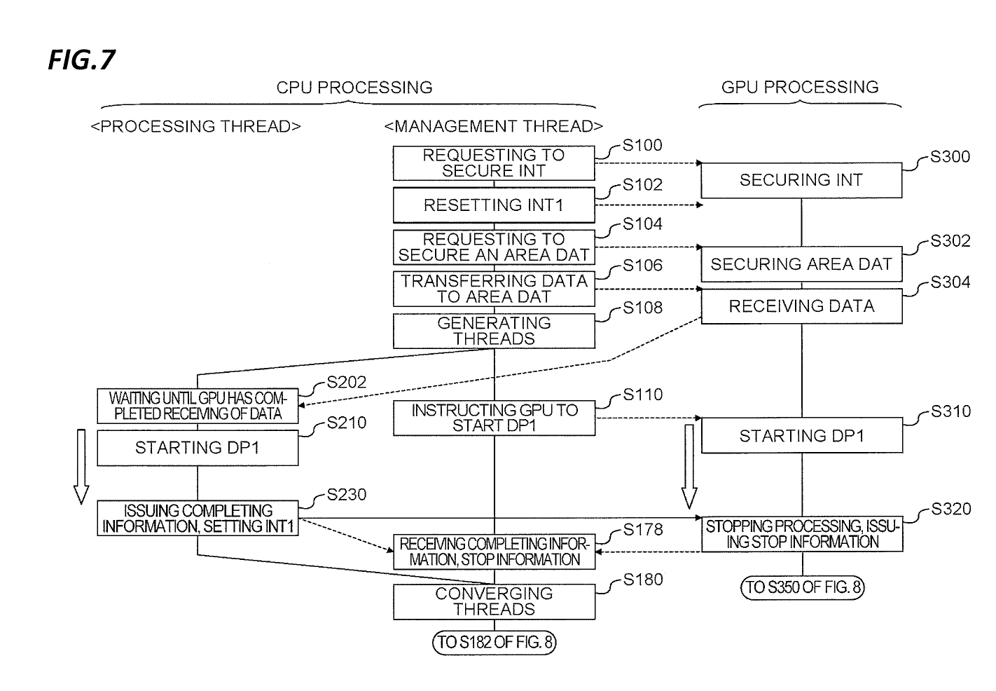

The information processing apparatus 1000 may include a plurality of CPUs 100 or a plurality of GPUs 200. That is, in the processes illustrated in FIG. 5 and FIG. 6, and thereafter, that is, FIG. 7 through FIG. 21, each of a CPU group 100 of the plurality of CPUs and a GPU group 200 of the plurality of GPUs may be allowed to execute the common data processing, respectively. In this case, the result of the data processing, which has been completed first among all of the data processings by the CPU group 100 of the plurality of CPUs and all of the data processings by the GPU group 200 of the plurality of GPUs, is used in a data processing after the completed data processing. When all of the data processings by one of the CPU group 100 and the GPU group 200 are completed, the data processing by the other of the CPU group 100 and the GPU group 200 may be stopped.

Further, each of three or more devices (a processor such as the CPU, an accelerator such as the GPU) may be allowed to execute the common data processing and use the result of the data processing which has been completed first in a data processing thereafter. For example, a CPU, a GPU having a high double-precision computation capability, and a GPU having a high degree of parallelism and wide memory bandwidth may be allowed to compete for an arithmetic operation time for the common data processing. Otherwise, one arithmetic core of the CPU, four arithmetic cores of the CPU, two GPUs may be allowed to compete for an arithmetic operation time for the common data processing.

FIG. 5 illustrates an exemplary operation of the information processing apparatus 1000 illustrated in FIG. 4. The CPU 100 and the GPU 200 execute the program to implement the processing operations of FIG. 5. That is, FIG. 5 illustrates the contents of the control program of the information processing apparatus and the contents of a control method of the information processing apparatus. In the processing of the CPU 100, the processings represented in a bolded line indicates the contents of the management program which manages the operations of the CPU 100 and the GPU 200. The arrow represented in a solid line indicates that the data processing is in progress.

In FIG. 5, a data processing DP1 executed by the CPU 100 is completed earlier than the data processing DP1 executed by the GPU 200. The processing of the CPU 100 is executed by the execution unit 110 and the processing of the GPU 200 is executed by the execution unit 210. In this example, a second data processing DP2 executed by the CPU 100 and the GPU 200 is executed using a result of the first data processing DP1.

At step S100, the CPU 100 requests the GPU 200 to secure a plurality of stop information areas INTs. At step S300, the GPU 200 secures a plurality of stop information areas INT in a register which is readable by the GPU 200 or in a storage area such as the storage device 400. At step S102, the CPU 100 resets a stop information area INT1, which corresponds to the data processing DP1 executed first among the stop information areas INTs, to a “non-stopped” state.

Subsequently, at step S104, the CPU 100 requests the GPU 200 to secure the data area DAT which stores the data used in the data processing DP1 by the GPU 200. In the meantime, since the transferring of data to the data area DAT requires a predetermined number of clock cycles, the data area DAT may be secured at once to be corresponded to the plurality of data processings DP1, DP2. Accordingly, the frequency of data transferring may be made lower as compared to a case where data is transferred between the CPU 100 and the GPU 200 for each data processing DP1, DP2, and thus, the efficiency of the data processing by the information processing apparatus may be enhanced.

At step S302, the GPU 200 secures the data area DAT in a storage area such as the storage device 400 readable and writable by the GPU 200. In the meantime, the stop information area INT and the data area DAT may be secured by the CPU 100 without being passed through the GPU 200.

At step S106, the CPU 100 transfers the data used in a first data processing DP1 to the data area DAT. At step S304, the GPU 200 receives the data used in the data processing DP1 and writes the received data in the data area DAT. Here, the GPU 200 may notify the CPU 100 that the receipt of data has been completed.

At step S110, the CPU 100 instructs the GPU 200 to start the data processing DP1. At step S310, the GPU 200 starts execution of the data processing DP1 using data written in the data area DAT based on the instruction to start the data processing DP1.

At step S210, the CPU 100 starts the data processing DP1 by the execution unit 110. In the meantime, the processing sequence of step S110, S210 may be reversed with each other. According to the processings of steps S210 and S310, the CPU 100 and the GPU 200 execute the common data processing DP1 in parallel using the same data. Here, the data to be obtained by the data processing DP1 executed by both the CPU 100 and the GPU 200 are the same data. In order to ensure that the data to be obtained by the data processing DP1 executed by the CPU 100 and the GPU 200 are the same data, when the processing of step S210 causes the data area DAT to be overwritten, the processing of step S210 may start after the transferring to the overwritten area is completed at step S304.

At step S150, the CPU 100 sets the stop information area INT1 to a “stop request” state in response to the completing of the data processing DP1 by the execution unit 110. At this time, the data processing DP1 by the GPU 200 has not been completed. At S320, the GPU 200 executes a stop processing which stops the data processing DP1 being executed based on the “stop request” from the CPU 100. Also, after stopping the data processing DP1, the GPU 200 issues stop information to the CPU 100 indicating that the data processing DP1 is stopped.

At step S182, the CPU 100 resets a stop information area INT2, which corresponds to the data processing DP1 to be executed for the second time, among the stop information areas INTs, to a “non-stopped” state. In the meantime, step S182 may be executed along with step S102.

At step S184, the CPU 100 transfers the result obtained by the data processing DP1 to the data area DAT. At step S350, the GPU 200 receives the result of the data processing DP1 executed by the CPU 100. Here, the GPU 200 may notify the CPU 100 that the reception of the result of the data processing DP1 has been completed. Subsequently, at step S190, the CPU 100 instructs the GPU 200 to start the data processing DP2.

At step S380, the GPU 200 starts the data processing DP2 using the result obtained by the data processing DP1 and stored in the data area DAT based on the instruction to start the data processing DP2. At step S260, the CPU 100 starts the data processing DP2 by the execution unit 110 using the result obtained by the data processing DP1. In the meantime, the processing sequence of steps S190, S260 may be reversed with each other.

Thereafter, processings that are the same or similar to the processings from step S150 to step S260 and from step S320 to step S380 may be executed, and these processings are repeated as needed. However, when the data processing DP2 by the GPU 200 is completed earlier than the data processing by the CPU 100, the processings that are the same or similar to processings of steps S230, S174, S176, S182 and steps S340, S342 in the flow illustrated in FIG. 6 are executed instead of the processings from step S150 to step S184 and steps S320, S350.

In other words, when the data processing DP2 by the CPU 100 is completed earlier than the data processing DP2 by the GPU 200, the data processing by the GPU 200 is stopped and the result of the data processing DP2 by the CPU 100 is adopted. When the data processing DP2 by the GPU 200 is completed earlier than the data processing by the CPU 100, the data processing by the CPU 100 is stopped and the result of the data processing DP2 by the GPU 200 is adopted.

When an interrupt request may be issuable from the CPU 100 to the GPU 200, an interrupt request which stops the data processing DP1 may be issued from the CPU 100 to the GPU 200 instead of setting of the stop information area INT1 at step S150. In this case, the processings of steps S100, S300 may not be executed and thus, the stop information area INT may not be secured. In the meantime, the stop information area INT may be used as an interrupt flag which requests to handle an interrupt. Further, when an interrupt request may be issuable from the GPU 200 to the CPU 100, the interrupt request indicating that the data processing DP1 is stopped may be issued from the CPU 100 to the GPU 200 instead of issuing the stop information at step S320.

At step S106, S304, when all of the data necessary for the data processing by the GPU 200 may not be transferred at once, for example, data may be copied into the storage device 300 managed by the CPU 100. Also, the CPU 100 may cause the GPU 200 to execute the data processing while dividing the data copied, for example, in the storage device 300 into several segments and transferring the divided data to the GPU 200 several times. The CPU 100 executes the data processing using the original data before being copied and executes a rewriting of the original data based on the data processing. Even in this case, the GPU 200 executes the data processing using the copied data and thus, the GPU 200 does not use the data rewritten by the CPU 100. That is, the GPU 200 does not execute the data processing using erroneous data.

FIG. 6 illustrates another exemplary operation of the information processing apparatus illustrated in FIG. 4. The same reference numerals are given to the processings that are the same or similar to the processings illustrated in FIG. 5, and the details thereof will be omitted. The CPU 100 and the GPU 200 execute the program to implement the processing operations of FIG. 6. That is, FIG. 6 illustrates the contents of the control program of the information processing apparatus and the contents of a control method of the information processing apparatus.

In the example illustrated in FIG. 6, a data processing DP1 executed by the GPU 200 is completed earlier than the data processing DP1 executed by the CPU 100. The processings from step S100 to step S210, step S260 and from step S300 to step S310 and step S380 are the same or similar to FIG. 5.

At step S340, in response to the completion of the data processing DP1, the GPU 200 issues stop information to the CPU 100 indicating that the data processing DP1 is stopped. At step S230, the CPU 100 executes a stop processing which stops the data processing DP1 being executed based on the stop information from the GPU 200.

At step S174, the CPU 100 issues a transfer request for the result of data processing DP1 stopped by the GPU 200 to the GPU 200. At step S342, the GPU 200 transfers the result of data processing DP1 to the CPU 100 based on the transfer request. At step S176, the CPU 100 receives the result of data processing DP1 transferred from the GPU 200.

Thereafter, as illustrated in FIG. 5, the CPU 100 executes the processings of steps S182, S190, S260, and the GPU 200 executes the processing of step S380. Thereafter, the processings that are the same or similar to processings of steps S230, S174, S176, S182, S190, S260, and steps S340, S342, S380 are executed, and these processings are repeated as needed. However, when the data processing DP2 by the CPU 200 is completed earlier than the data processing by the GPU 200, the processings that are the same or similar to processings of steps S150, S182, S184 and steps S320, S350 in the flow illustrated in FIG. 5 are executed instead of the processings of steps S230, S174, S176, S182 and steps S340, S342.

In other words, when the data processing DP2 by the CPU 100 is completed earlier than the data processing by the GPU 200, the data processing by the GPU 200 is stopped and the result of the data processing DP2 by the CPU 100 is adopted. When the data processing DP2 by the GPU 200 is completed earlier than the data processing by the CPU 100, the data processing DP2 by the CPU 100 is stopped and the result of the data processing DP2 by the GPU 200 is adopted.

As described above, in this embodiment, similarly to the embodiments illustrated from FIG. 1 to FIG. 3, the result of the data processing which has been completed first may actually be used in the data processing where it is unable to determine which one of the sequential processing and the parallel processing has been completed first, and thus, the processing efficiency of the information processing apparatus may be enhanced. That is, the data processing times of the CPU 100 and the GPU 200 may not be analyzed in advance and thus, the data processing may be executed with a high speed as compared to conventional techniques.

The GPU 200 (or the CPU 100) which has stopped the data processing DP1 starts the next data processing DP2 using the result of the data processing DP1 transferred from the CPU 100 (or the GPU 200) which has completed the data processing DP1. Accordingly, a start timing of the data processing DP2 by the GPU 200 (or the CPU 100) which has stopped the data processing DP1 may be matched to a start timing of the data processing DP2 by the CPU 100 (or the GPU 200) which has completed the data processing DP1. As a result, even when the next data processings are executed sequentially using the result of the data processing, the result obtained by each data processing which has completed first may be used and thus, the performance efficiency of the information processing apparatus may be enhanced.

FIG. 7 to FIG. 13 each illustrates exemplary operations of the information processing apparatus according to another embodiment. Similar reference numerals are given to the same or similar processes as the processes illustrated in FIG. 5 and FIG. 6, and the details thereof will be omitted.

The information processing apparatus, similarly to FIG. 4, may include the CPU 100, an accelerator such as GPU 200 and the storage devices 300, 400, and the information processing apparatus may be installed in the system SYS. In this embodiment, the CPU 100 generates a processing thread which executes the data processing DP1 and a management thread which manages the processing thread before executing the data processing DP1, and converges the threads after the data processing DP1 is completed or stopped. For example, the generation and convergence of the threads are described using sections or a section when using the OpenMP (registered trademark).

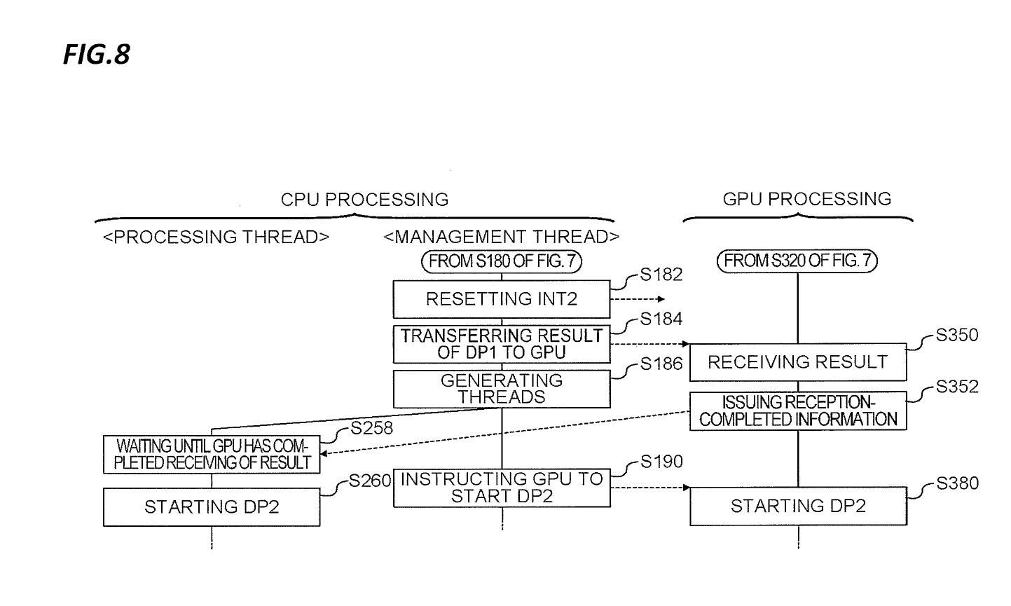

The CPU 100 and the GPU 200 execute the program to implement the processing operations of FIG. 7 to FIG. 13. That is, FIG. 7 to FIG. 13 illustrate the contents of the control program of the information processing apparatus and the contents of a control method of the information processing apparatus. FIG. 7 and FIG. 8 illustrate an example in which the data processing DP1 executed by the CPU 100 is completed earlier than the data processing DP1 executed by the GPU 200, as in FIG. 5.

In FIG. 7, the CPU 100 generates the processing thread and the management thread at step S108 after transferring the data used in data processing DP1 to the data area DAT at step S106. At step S202, the processing thread waits until the GPU 200 has completed receiving of data. After the receiving of data by the GPU 200 has been completed, the processing thread starts executing the data processing DP1 at step S210. In the meantime, when the data processing DP1 is a processing by which the data area DAT is not overwritten, step S202 may not be necessary.

At step S230, in response to the completion of the data processing DP1, the processing thread issues completion information to the management thread indicating that the data processing DP1 is completed, and sets the stop information area INT1 to a “stop request” state. At this time, the data processing DP1 by the GPU 200 has not been completed. The processing of step S320 by the GPU 200 is similar to that of FIG. 5.

The management thread receives the completing information from the processing thread and the stop information from the GPU 200 at step S178, and the CPU 100 converges the processing thread and the management thread at step S180.

Subsequently, the CPU 100 generates the processing thread and the management thread at step S186 after the result obtained by data processing DP1 is transferred from the management thread to the data area DAT at step S184 as illustrated in FIG. 8. At step S352, the GPU 200 issues reception-completed information to the CPU 100 indicating that the receipt of the result of the data processing DP1 from the CPU 100 has been completed. At step S258, the processing thread waits for the reception-completed information from the GPU 200. Also, at step S260, the processing thread starts the data processing DP2 based on the reception-completed information from the GPU 200.

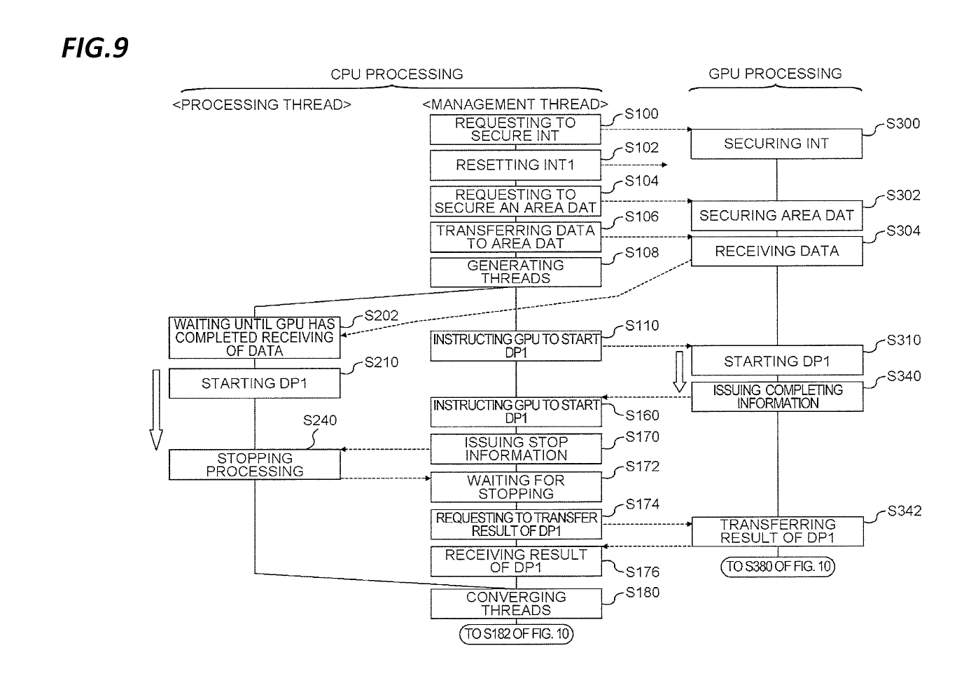

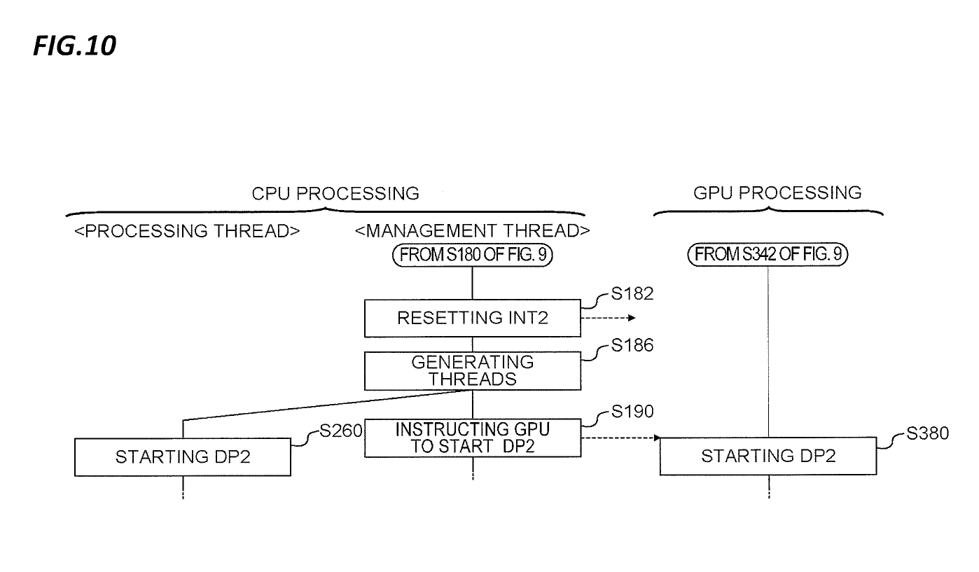

FIG. 9 and FIG. 10 illustrate an example in which the data processing DP1 executed by the GPU 200 is completed earlier than the data processing DP1 executed by the CPU 100.

At step S160 of FIG. 9, the management thread receives the completing information from the GPU 200 indicating that the data processing DP1 is completed. Thereafter, at step S170, the management thread issues stop information to the processing thread to stop the data processing DP1 being executed. At step S172, the management thread waits until the data processing DP1 by the processing thread is stopped. Also, at step S180, the management thread converges the threads after transferring the result of the data processing DP1 by the processing thread.

In the examples of FIG. 9 and FIG. 10, the GPU 200 knows the result of the data processing DP1 in order to complete the data processing DP1. Accordingly, the processings of steps S184, S350, S352, S258 illustrated in FIG. 8 are not executed in FIG. 10. Other processings of the flow of FIG. 10 are the same or similar to FIG. 8.

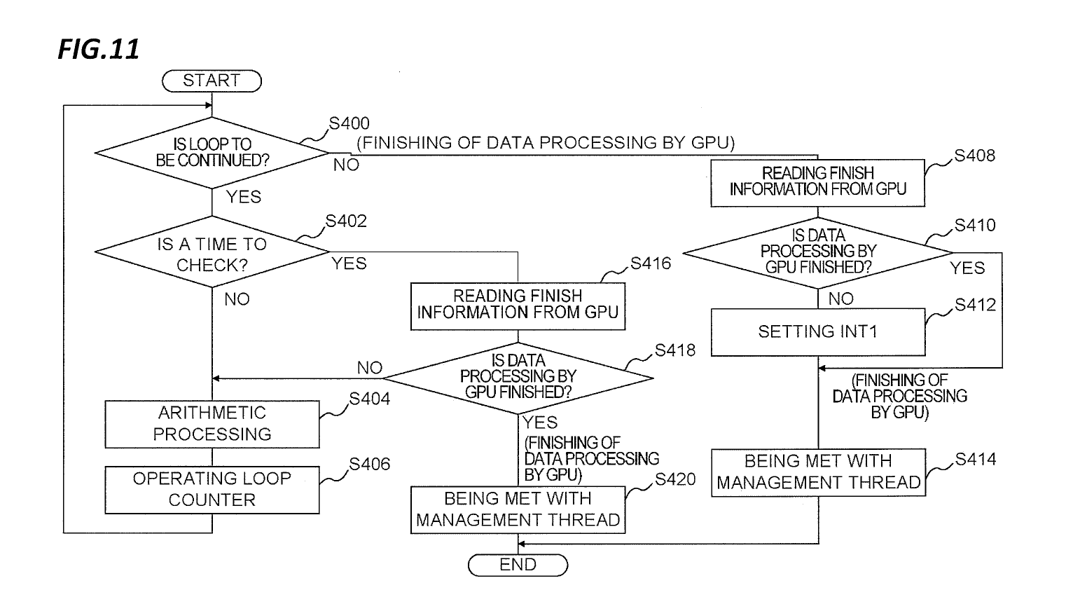

FIG. 11 illustrates an exemplary operation of the processing thread which has started the data processing DP1 illustrated in FIG. 7. For example, the processing operations of FIG. 11 correspond to the processings of step S210, S230 illustrated in FIG. 7 and the processing of step S240 illustrated in FIG. 9. In the meantime, in order to simplify the description, the data processing DP1 is assumed to be a single loop processing.

At step S400, the processing thread determines whether the loop which repeatedly executes the data processing is to be continued, that is, whether the data processing has not yet been completed. When it is determined that the data processing has not yet been completed, the process proceeds to step S402. When the data processing has been completed, the process proceeds to step S408.

At step S402, the processing thread determines whether it is a time to check the state of the progress of the data processing DP1 by the GPU 200. When the time to check has arrived, the process proceeds to step S416, and when the time to check has not arrived, the process proceeds to step S404. For example, the frequency of checking by the processing at step S416, S418 is set such that the load caused by the checking by the processing thread amounts to about 1% to 10% of load caused by the data processing by the processing thread. For example, at step S402, the frequency of checking is set such that the checking is performed once per 64 data processing times, and the process proceeds to step S416.

At step S404, the processing thread executes an arithmetic processing. Subsequently, at step S406, the processing thread operates a loop counter (e.g., increment, and the process goes back to step S400.

When the time to check the progress of the data processing DP1 by the GPU 200 has arrived, the processing thread reads the completing information indicating that the data processing DP1 by the GPU 200 is completed from the management thread using, for example, a polling scheme at step S416. At step S418, the processing thread determines whether the data processing DP1 by the GPU 200 is completed based on the completing information result read at step S416. When it is determined that the data processing DP1 by the GPU 200 has been completed, the process proceeds to step S420 and when the data processing DP1 by the GPU 200 has not yet been completed, the process proceeds to step S404. At step S420, the processing thread meets with the management thread.

When the data processing DP1 by the CPU 100 has been completed, the processing thread reads the completing information from the GPU 200 using, for example, a polling scheme at step S408. At step S410, the processing thread determines whether the data processing DP1 by the GPU 200 is completed based on the completing information result read at step S408. When the data processing DP1 by the GPU 200 has been completed, it is determined that the data processings by the CPU 100 and the GPU 200 are completed almost simultaneously, and the process proceeds to step S414. When the data processing DP1 by the GPU 200 has not yet been completed, the process proceeds to step S412.

At step S412, the processing thread sets the stop information area INT1 to a “stop request” state. For example, the processing of step S412 is executed by an atomic process. At step S414, the processing thread meets with the management thread.

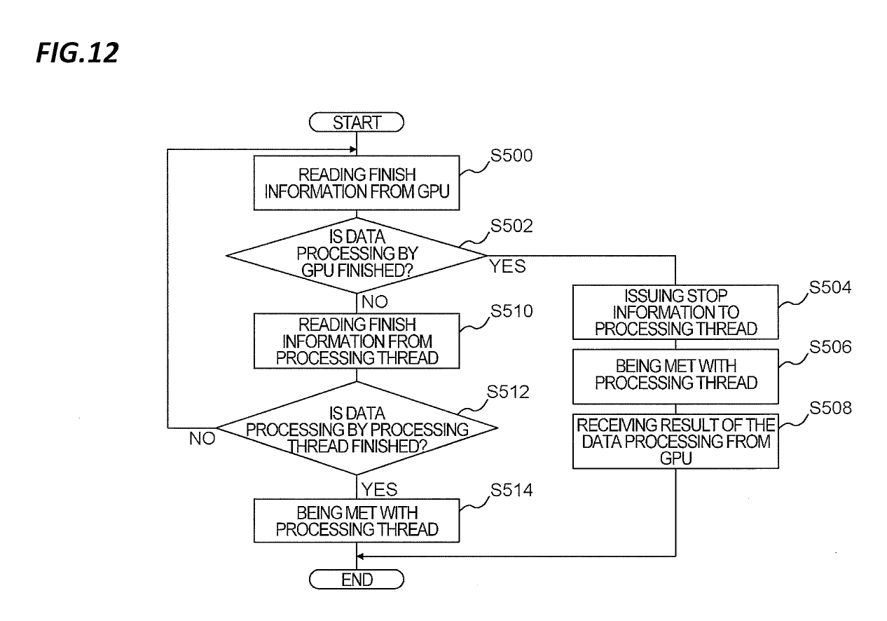

FIG. 12 illustrates an exemplary operation of the management thread which has started the data processing DP1 illustrated in FIG. 7. For example, the processing operations of FIG. 12 correspond to the processing of step S178 illustrated in FIG. 7 and the processings of steps S160, S170, S172, S174, S176 illustrated in FIG. 9.

First, the management thread reads the completing information indicating that the data processing DP1 by the GPU 200 is completed from the GPU 200 using a polling scheme or the like at step S500. At step S502, the management thread determines whether the data processing DP1 by the GPU 200 is completed based on the result of the completing information read at step S500. When it is determined that the data processing DP1 by the GPU 200 has been completed, the process proceeds to step S504. When the data processing DP1 by the GPU 200 has not yet been completed, the process proceeds to step S510.

At step S504, based on the completing of the data processing DP1 by the GPU 200, the management thread issues stop information to the processing thread to stop the data processing DP1 being executed. For example, the processing of step S504 is executed by an atomic process. At step S506, the management thread meets with the processing thread. That is, at step 506 and step S420 illustrated in FIG. 11, the management thread and the processing thread meet with each other. Subsequently, at step S508, the management thread receives the result of the data processing DP1 transferred from the GPU 200. In the meantime, even when the data processing DP1 by the processing thread is also completed, the processing of step S508 may be omitted.

At step S510, the management thread reads the completing information indicating that the data processing DP1 by the processing thread is completed from the processing thread using, for example, a polling scheme. Subsequently, at step S512, the management thread determines whether the data processing DP1 by the processing thread is completed based on the result of the completing information read at step S510. When it is determined that the data processing DP1 by the processing thread is completed, the process proceeds to step S514. When the data processing DP1 by the processing thread is not completed, the process goes back to step S500. At step S514, the management thread meets with the processing thread. That is, at step 514 and at step S414 illustrated in FIG. 11, the management thread and the processing thread meet with each other.

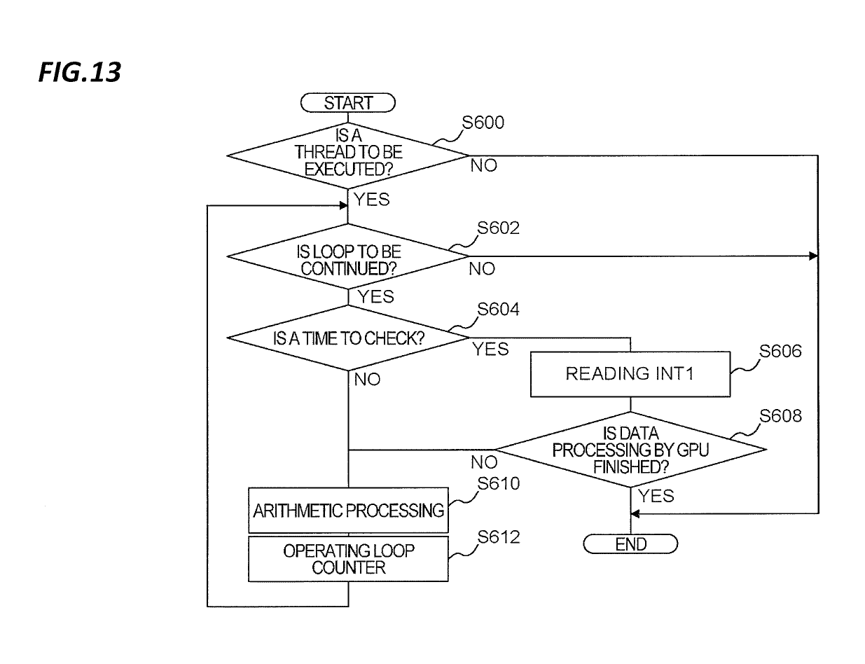

FIG. 13 illustrates an example of each thread of the GPU 200 which has started the data processing DP1 illustrated in FIG. 7. For example, the operation of FIG. 13 corresponds to the processings of steps S310, S320 illustrated in FIG. 7. In the meantime, FIG. 13 illustrates the operation of each thread by the GPU 200. For example, the processings of steps S300, S302, S304 of FIG. 7, the processings of step S350, S352 of FIG. 8 and the processing of step S340 of FIG. 13 are not illustrated in FIG. 13. The processings of steps S300, S302, S304 of FIG. 7, the processings of step S350, S352 of FIG. 8 and the processing of step S340 of FIG. 13 are executed by, for example, a management unit of the GPU 200 which manages the thread executed by the GPU 200.

At step S600, the GPU 200 determines whether a thread to be executed continuously is a thread to be executed (execution thread) or not to be executed (non-execution thread). When it is determined that the thread is the execution thread, the process proceeds to step S602, and when the thread is the non-execution thread, the process is completed.

At step S602, the GPU 200 determines whether the loop which executes the data processing repeatedly is to be continued. When the data processing is not completed, the process proceeds to step S604, and when all of the data processings are completed, the process is completed.

At step S604, the GPU 200 determines whether it is a time to check the state of progress of the data processing DP1. When the time to check has arrived, the process proceeds to step S606. When the time to check has not arrived, the process proceeds to step S610. For example, the frequency of checking by the processing at step S606, S608 is set as follows.

For example, the load of the GPU 200 due to the checking is set to be about 1% to 10% of the load due to the data processing (arithmetic processing). It is set such that the arithmetic processing at step S610 consumes 100 clock cycles and a reading processing (memory latency) for the stop information area INT1 consumes 200 clock cycles at step S606. When the stop information area INT1 is checked per 64 arithmetic processing times, an increment of the load of the GPU 200 due to the checking may be roughly estimated about 3% (e.g., 200 clock cycles/(100 clock cycle×64 times)). Similarly, when it is set such that the arithmetic processing consumes 100 clock cycles and a reading processing (memory latency) for the stop information area INT1 consumes 200 clock cycles, an increment of the load of the GPU 200 may be roughly estimated about 2% (e.g., 200 clock cycles/(200 clock cycle×64 times)).

At step S606, the GPU 200 reads a value set in the stop information area INT1. Subsequently, at step S608, the GPU 200 determines whether the data processing DP1 by the GPU 200 is completed based on the result of the stop information area INT1 read at step S606. When it is determined that the data processing DP1 by the GPU 200 is completed, the process is completed. That is, the thread which is executing is stopped. When the data processing DP1 by the GPU 200 is not completed, the process proceeds to step S610.

At step S610, the GPU 200 executes the arithmetic processing. Subsequently, at step S612, the GPU 200 manipulates a loop counter (e.g., an increment), the process goes back to step S602.

As described above, in this embodiment, similar to the embodiments illustrated in FIG. 1 to FIG. 6, since the result obtained by the data processing which has been completed first may actually be used in a data processing where it is unable to determine which one of the sequential processing and the parallel processing is completed first, the processing efficiency of the information processing apparatus may be improved. That is, the thread may be executed with a high speed without analyzing the degree of parallelism of the thread which executes the data processing.

The processing of the CPU 100 may be split into the processing thread which executes the data processing DP1 and the management thread which manages the processing thread and the GPU 200, and as a result, the difference between the original program of the data processing DP1 and the program executed by the processing thread may be made smaller. Accordingly, the program which executes the data processing DP1 may be easily created from the original program as compared to the case where the processing thread and the management thread are not split.

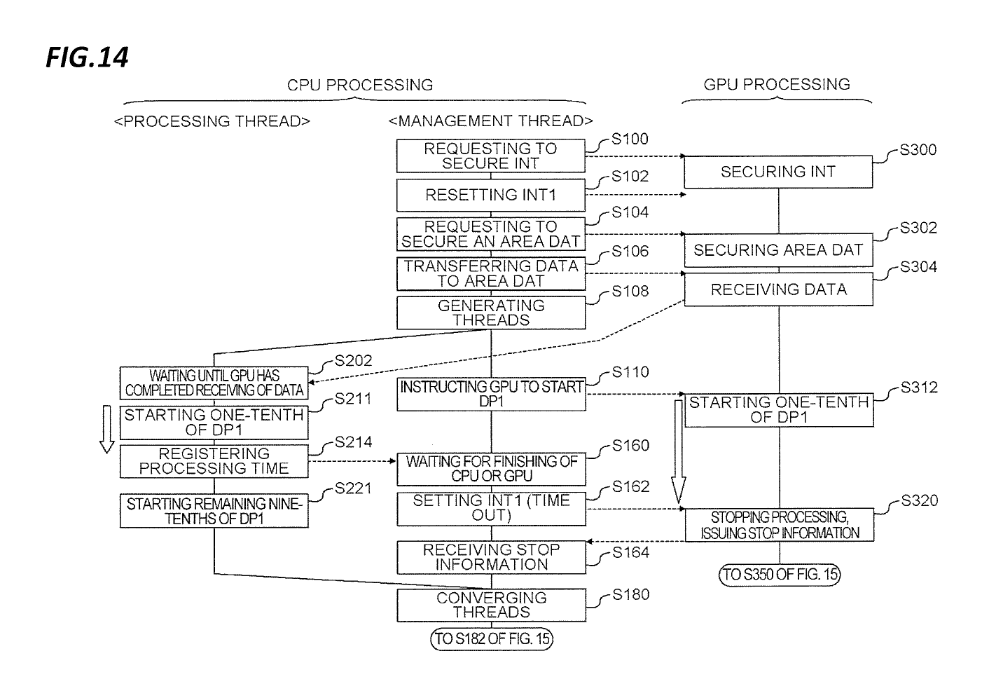

FIG. 14 to FIG. 19 illustrate exemplary operations in the information processing apparatus according to another embodiment. Similar reference numerals are given to the same process or similar process as the processes illustrated in FIG. 5 to FIG. 10, and the details thereof will be omitted.

The information processing apparatus, similar to FIG. 4, includes, for example, the CPU 100, an accelerator such as the GPU 200, and the storage devices 300, 400. The information processing apparatus may be installed in the system SYS. In this embodiment, as in FIG. 7 to FIG. 10, the CPU 100 generates a processing thread which executes the data processing DP1 and the management thread which manages the GPU 200 before executing the data processing DP1. The CPU 100 also converges the threads after the data processing DP1 is completed or stopped.

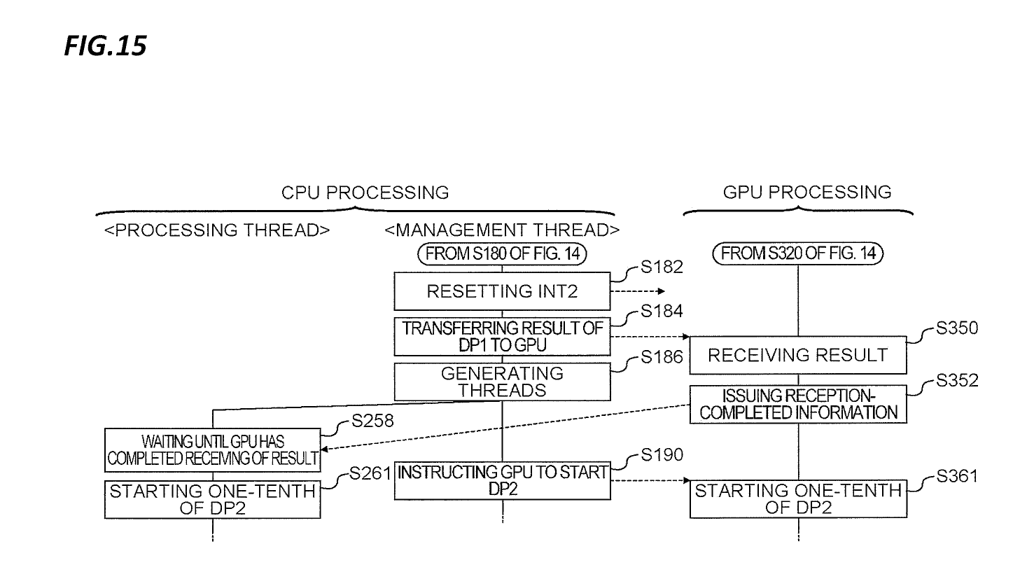

FIG. 14 and FIG. 15 illustrate an example in which the data processing DP1 executed by the processing thread is completed earlier than the data processing DP1 executed by the GPU 200 as in FIG. 5, FIG. 7 and FIG. 8. The processing thread waits until the reception of data by the GPU 200 has been completed and thereafter, starts the execution of one-tenth (10%) of the data processing DP1 at step S211. Subsequently, at step S214, the processing thread registers the processing time consumed of the one-tenth of the data processing DP1 in an area that is recognizable by the management thread. The processing thread which has completed the one-tenth of data processing starts execution of the remaining nine-tenth (90%) of the data processing DP1 at step S221.

At step S312, the GPU 200 starts the one-tenth (10%) of the data processing DP1 based on the instruction to start the data processing DP1. At step S160, the management thread waits for completing of the one-tenth of the data processing by the processing thread and the GPU 200. The management thread recognizes the completing of the one-tenth of the data processing by the processing thread based on the registration of the processing time by the processing thread.

At step S162, the management thread sets the stop information area INT1 to a “stop request” state (timed out) based on the fact that completing information has not been received from the GPU 200 within a predetermined time after instructing the GPU to start the data processing DP1. Subsequently, at step S164, the management thread receives the stop information from the GPU 200, similarly to step S178 illustrated in FIG. 7. At step S180, the CPU 100 converges the processing thread and the management thread.

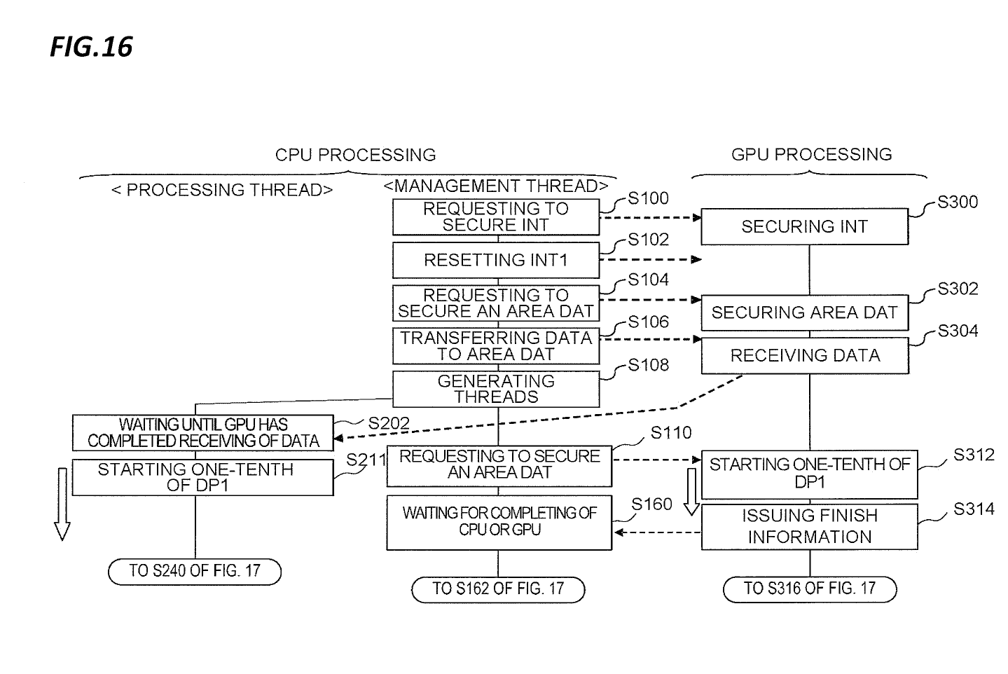

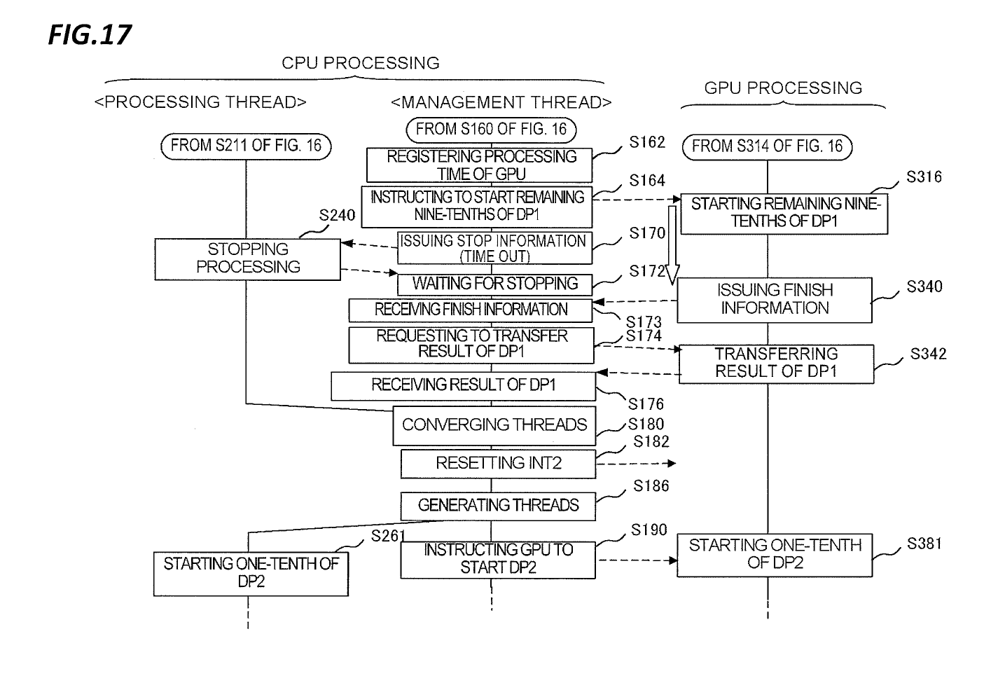

Subsequently, the processing illustrated in FIG. 15 may be executed as in FIG. 8. However, the one-tenth of the data processing DP2 may start at each step of S261, S381. Thereafter, when the one-tenth of the data processing by the processing thread is faster than the one-tenth of the data processing by the GPU 200, the processings that are the same or similar to the processings of steps S214, S221, S160, S162, S164, S180, S320 of FIG. 14 may be executed. When the one-tenth of the data processing by the GPU 200 is faster than the one-tenth of the data processing by the processing thread, the processings that are the same or similar to processings of steps S314, S160 of FIG. 16 and FIG. 17 may be executed.

In other words, when the one-tenth of the data processing by the processing thread is completed earlier than the one-tenth of the data processing by the GPU 200, the data processing by the GPU 200 may be stopped, and the one-tenth of the data processing DP2 by the processing thread may be adopted. Also, the remaining nine-tenths of the data processing DP2 may be executed by the processing thread. When the one-tenth of the data processing DP2 by the GPU is completed earlier than the one-tenth of the data processing DP2 by the processing thread, the data processing by the processing thread may be stopped, and the result of one-tenth of the data processing DP2 by the GPU 200 may be adopted. Also, the remaining nine-tenths of the data processing DP2 may be executed by the GPU 200.

FIG. 16 and FIG. 17 illustrate an example in which the data processing DP1 executed by the GPU 200 is completed earlier than the data processing DP1 executed by the processing thread as in FIG. 6, FIG. 9 and FIG. 10. At step S314 of FIG. 16, the GPU 200 issues the completing information to the management thread indicating that the data processing is completed after the one-tenth of the data processing DP1 is completed. At step S160, the management thread receives the completing information from the GPU 200. At this time, the one-tenth of the data processing DP1 by the processing thread has not been completed.

At step S162 of FIG. 17, the management thread registers the processing time consumed for one-tenth of the data processing DP1 by the GPU 200 in, for example, a register based on the completing information from the GPU 200. Subsequently, at step S164, the management thread instructs the GPU 200 to start execution of the remaining nine-tenths (90%) of the data processing DP1. At step S316, the GPU 200 starts the remaining nine-tenths (90%) of the data processing DP1 based on the instruction to start the data processing DP1.

At step S170, the management thread issues the stop information to the processing thread to stop the data processing DP1 being executed by the GPU 200 (time out) based on the fact that the completing information has not been received from the processing thread within a predetermined time after instructing the processing thread to start the data processing DP1.

Thereafter, as in FIG. 9, the result of the remaining nine-tenths of the data processing DP1 executed by the GPU 200 is transferred from the GPU 200 to the processing thread through the management thread, and as a result, the threads converge (S174, S176, S180, S342). Also, as in FIG. 15, the stop information area INT2 is reset to the “non-stopped” state, and the processing thread and the management thread are generated again and thus, the execution of the one-tenth of the data processing DP2 is started by each of the processing thread and the GPU 200 (S182, S186, S190, 261, S381).

Thereafter, when the execution of the one-tenth of the data processing by the processing thread is faster than the execution of the one-tenth of the data processing by the GPU 200, the processings that are the same or similar to the processings of steps S214, S221, S160, S162, S164, S180, S320 of FIG. 14 may be executed. When the execution of the one-tenth of the data processing by the GPU is faster than the execution of the one-tenth of the data processing by the processing thread, the processings that are the same or similar to processings of steps S314, S160 of FIG. 16 and FIG. 17 may be executed.

In other words, when the one-tenth of the data processing by the processing thread is completed earlier than the one-tenth of the data processing by the GPU 200, the data processing by the GPU 200 may be stopped, and the result of the one-tenth of the data processing DP2 by the processing thread may be adopted. Also, the remaining nine-tenths of the data processing DP2 may be executed by the processing thread. When the one-tenth of the data processing by the GPU 200 is completed earlier than the one-tenth of the data processing DP 2 by the processing thread, the data processing by the processing thread may be stopped, and the result of the one-tenth of the data processing DP2 by the GPU 200 may be adopted. Also, the remaining nine-tenths of the data processing DP2 may be executed by the GPU 200.

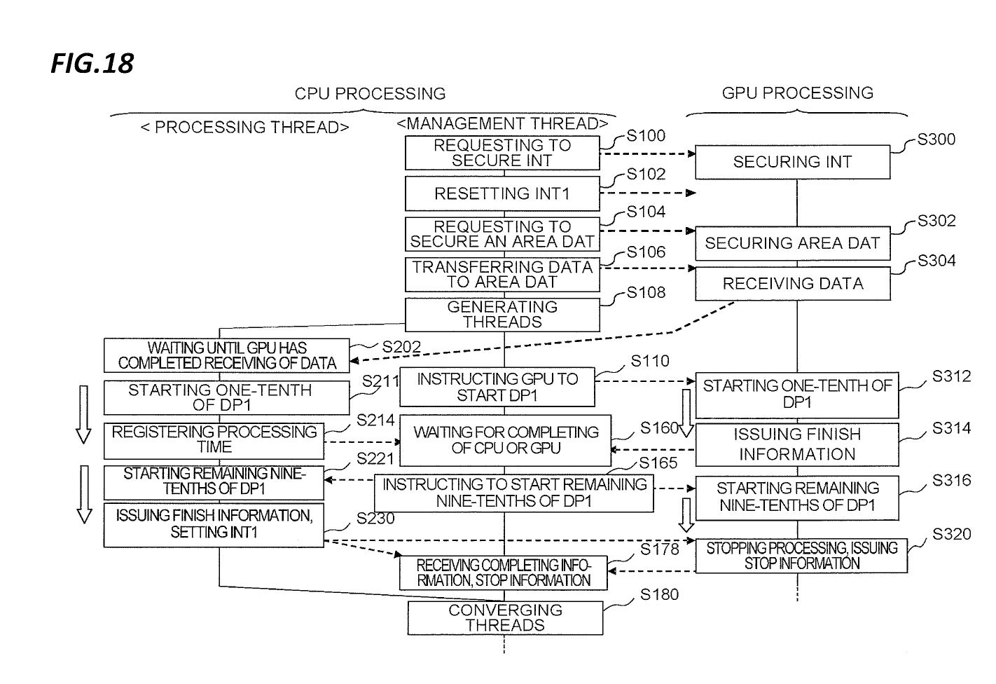

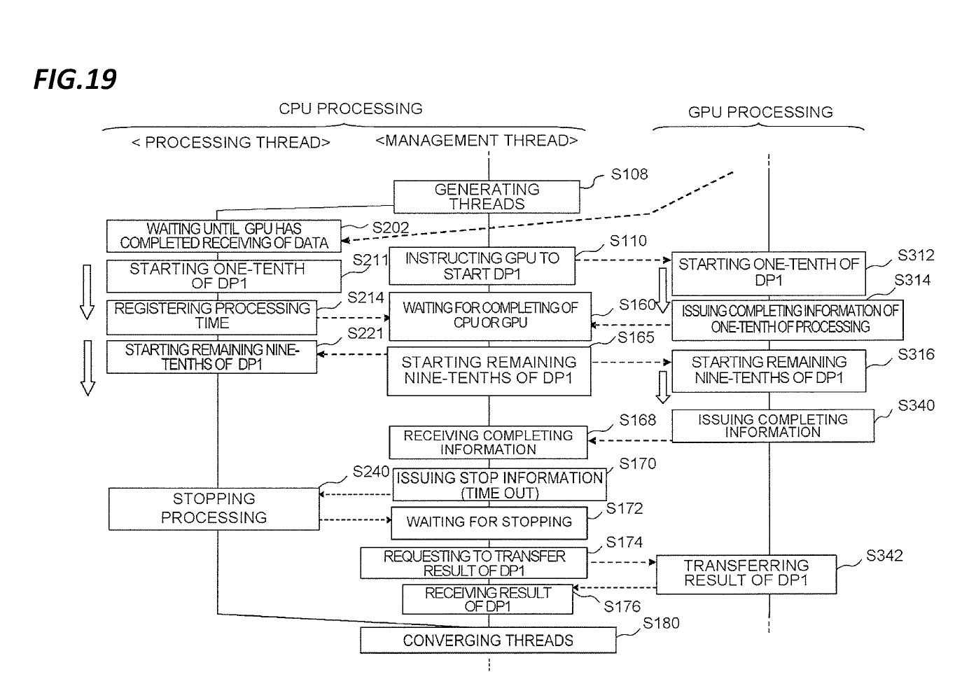

FIG. 18 and FIG. 19 illustrate another exemplary operation of the information processing apparatus which executes the process illustrated in FIG. 14. In FIG. 18 and FIG. 19, there is no difference of superiority between the processing times consumed by the execution of the one-tenth of the data processing DP1 by the processing thread executed by the processing thread and GPU 200, and thus, the remaining nine-tenths of the data processing DP1 may be executed by both of the processing thread and the GPU 200. Also, the result produced from one of the processing thread and the GPU 200 which has completed the remaining nine-tenths one of the data processing first may be used. FIG. 18 illustrates an example in which the execution of the remaining nine-tenths of the processing by the processing thread is completed earlier than the execution of the remaining nine-tenths of the processing by the GPU 200. FIG. 19 illustrates an example in which the execution of the remaining nine-tenths of the processing by the GPU 200 is completed earlier than the execution of the remaining nine-tenths of the processing by the processing thread.

At step S160 of FIG. 18, the management thread receives both of the completing information from the processing thread and the completing information from the GPU 200 within a predetermined time period after instructing the processing thread and the GPU to start the data processing DP1. The management thread determines that there is no difference of superiority between the processing times of the one-tenth of the data processing DP1 executed by each of the processing thread and GPU 200, and instructs both of the processing thread and the GPU 200 to execute the remaining nine-tenths of the data processing at step S165.

In FIG. 18, the execution of the remaining nine-tenths of the data processing by the processing thread is completed earlier than the execution of the remaining nine-tenths of the data processing by GPU 200 and thus, as in FIG. 7, the processing thread issues the completing information to set the stop information area INT1 to “stop request” state, and the remaining nine-tenths of the data processing by the GPU 200 is stopped (S230, S178, S320).

Thereafter, as in FIG. 14, the CPU 100 converges the processing thread and the management thread at step S180. Further, as in FIG. 15, the execution of the one-tenth of the next data processing DP2 may be started by each of the processing thread and the GPU 200.

In FIG. 19, the description of steps S100, S102, S104, S106, S300, S302, S304 of FIG. 18 are omitted. Similar reference numerals are given to the same process or similar process as the process illustrated in FIG. 18, and the details thereof will be omitted.

In FIG. 19, the execution of the remaining nine-tenths of the data processing DP 1 by the GPU 200 is completed earlier than the execution of the remaining nine-tenths of the data processing DP 1 by the processing thread. Accordingly, as in FIG. 9, the completing information is issued from the GPU 200 and thus, the execution of the remaining nine-tenths of the data processing DP 1 by the processing thread is stopped (S340, S168, S170, S172, S240). Further, as in FIG. 9, the result of the data processing DP1 is transferred from the GPU 200 to the management thread and thus, the threads may converge (step S174, S342, S176, S180). Thereafter, as in FIG. 15, the execution of one-tenth of the data processing by each of the processing thread and the GPU 200 may be started.

In FIG. 18 and FIG. 19, as in FIG. 15, the management thread waits for completing of the one-tenth of the data processing DP2 by each of the processing thread and the GPU 200 after the execution of the one-tenth of the data processing DP2 by each of the processing thread and the GPU 200 is started. Also, when the execution of the one-tenth of the data processing DP2 by the processing thread is completed earlier than the execution of the one-tenth of the data processing by the GPU 200, the data processing by the GPU 200 may be stopped and the result of one-tenth of the data processing DP2 by the processing thread may be adopted. The processing thread may execute the remaining nine-tenths of the data processing DP2 using the result obtained by execution of one-tenth of the data processing DP2.

When the one-tenth of the data processing DP2 by the GPU 200 is completed earlier than the one-tenth of the data processing by the processing thread, the data processing by the processing thread may be stopped and the one-tenth of the data processing DP2 by the GPU 200 may be adopted. Also, the GPU 200 executes the remaining nine-tenths of the data processing DP2 using the result obtained by execution of the one-tenth of the data processing DP2.

When there is no difference of priority between the processing times of the one-tenth of the data processing DP2 executed by each of the processing thread and GPU 200, the management thread instructs both of the processing thread and the GPU 200 to start the remaining nine-tenths of the data processing.

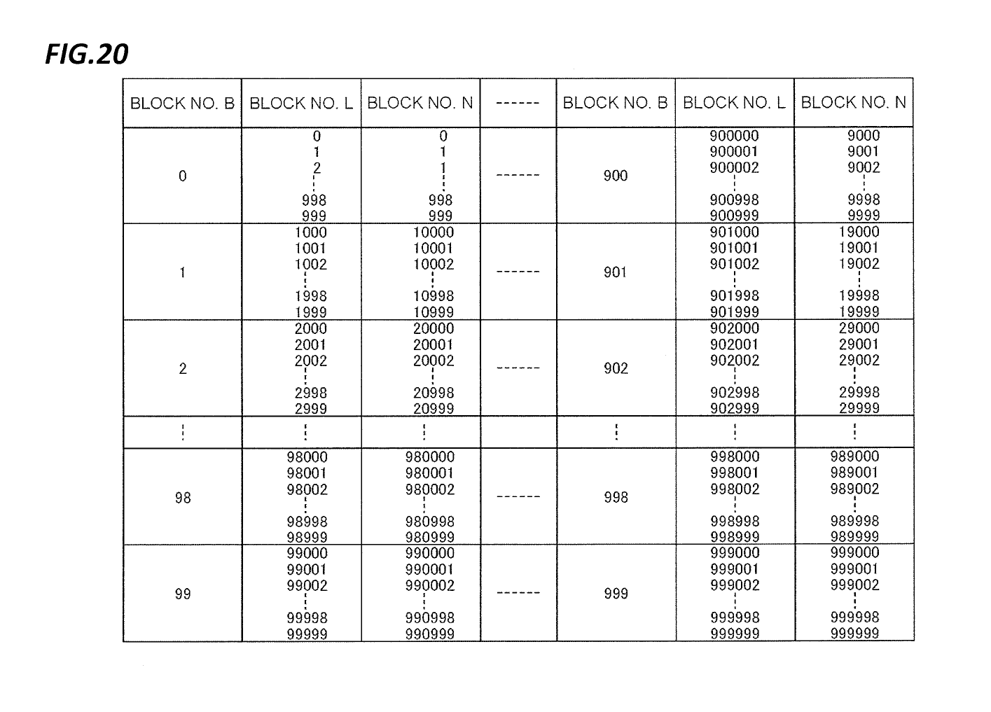

FIG. 20 illustrates a scheme in which the one-tenth of the data processing is distributed and executed. For example, in a case where one million threads are processed, each of the processing thread of the CPU 100 and the GPU 200 executes one hundred thousand threads at step S211 and step 312 of FIG. 14, FIG. 16, FIG. 18 and FIG. 19.

In this example, it is assumed that one thousand blocks each containing one thousand threads are sequentially processed. The block number B indicates a sequence of blocks to be dispatched to the CPU 100 and the arithmetic cores of the GPU 200. The thread number L indicates a serial number of one million threads processed by the CPU 100 and the arithmetic cores of the GPU 200. The thread number N is a serial number allocated to one million threads in advance, and generated from the equation (1) based on the block number B and the thread number L. For example, the equation (1) is described in a program, and the thread number N is generated using one hundred block number B (from 0 to 99) and one thousand thread numbers L (from 0 to 999).

N=L+((B%100)*10000)+((B/100)*1000) (1)

In the equation (1), “%” indicates a modulo operation. The thread to be dispatches to the CPU 100 and the GPU 200 is determined using the thread number N generated by the equation (1), such that one hundred thousand threads to be executed may be selected in a distributed manner among one million threads. Accordingly, the change of computational time may be averaged depending on data and thus, the entire processing time may be predicted by executing one-tenth of the data processing. Accordingly, a prediction accuracy for the processing time of the remaining nine-tenths of the data processing may be improved, as compared to a case where the processings corresponding to one hundred thousand thread numbers N (for example, from 0 to 99999) being continued are executed to check which processing time consumed by one of the CPU 100 and the GPU 200 is shorter than that of the other of the CPU 100 and the GPU 200. As a result, the prediction accuracy for a device (CPU 100 or GPU 200) which completes the data processing DP1 first may be improved, such that the processing efficiency of the information processing apparatus may be improved.

As described above, also in this embodiment, similarly to the embodiment illustrated in FIG. 3, a portion of the data processing is executed to determine which one of the sequential processing and the parallel processing is completed first and thus, a time period during which the first and the second arithmetic processing apparatuses 10, 20 execute the data processing in duplicate may be made shorter. Accordingly, a power consumption of the information processing apparatus may be reduced while improving the processing efficiency of the information processing apparatus.

Further, a portion of the data processing may be executed so that the CPU 100 (or the GPU 200) which completed the processing faster may execute the remaining portion of the data processing, and the result of the remaining portion of the data processing DP1 is transferred from the CPU 100 (or GPU 200) to the GPU 200 (or CPU 100). Accordingly, the next data processing DP2 by the GPU 200 (or CPU 100) which stops execution of the portion of the data processing DP1 may be executed in line with the data processing DP2 by the CPU 100 (or GPU 200) which has completed the execution of the data processing DP1. As a result, even when a portion of the next data processing is executed sequentially using the result of the data processing, the result of the CPU 100 or the GPU 200 which has completed the data processing first may actually be used in each data processing, and thus, the processing efficiency of the information processing apparatus may be improved.

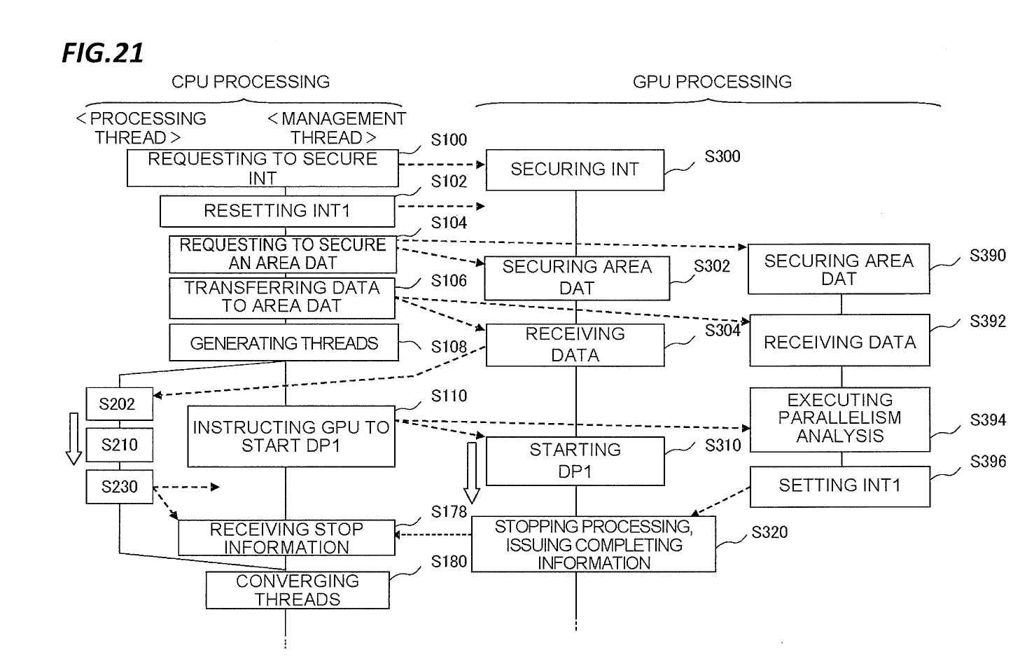

FIG. 21 illustrates an exemplary operation in the information processing apparatus according to another embodiment. For example, the information processing apparatus, as in FIG. 4, includes the CPU 100, an accelerator such as the GPU 200 and the storage devices 300, 400, and the information processing apparatus may be installed in the system SYS.

The CPU 100 and the GPU 200 execute the program to implement the operation of FIG. 21. That is, FIG. 21 illustrates the contents of the control program of the information processing apparatus and the contents of the control method of the information processing apparatus. The same reference numerals are given to the processings that are the same or similar to the processings illustrated in FIG. 7, and the details descriptions thereof will be omitted. Except for steps S390, S392, S394, S396, the processings are similar to those of FIG. 7.

For example, the information processing apparatus, as in FIG. 4, includes the CPU 100, an accelerator such as the GPU 200, and the storage devices 300, 400, and the information processing apparatus may be installed in the system SYS. In this embodiment, the GPU 200 analyzes the program which executes the data processing DP1 in parallel with the execution of the data processing DP1. Also, when it is determined that an erroneous result may be obtained by executing the data processings by a parallel processing, the data processing DP1 which is being executed by the GPU 200 may be stopped. In the meantime, the analyzing of the program may be executed by an accelerator other than the GPU 200 which executes the data processing DP1.

At step S390, the GPU 200 secures a data area DAT in a separate area from the area secured at step S302 based on the request to secure the data area DAT from the management thread. Subsequently, at step S392, the GPU 200 writes data received at step S204 in the data area DAT which is newly secured.

At step S394, the GPU 200 executes a parallelism analysis which determines whether the program executing the data processing DP1 may be executed in parallel with the execution of the data processing DP 1. When it is determined that an erroneous computation result may be obtained by the execution of the parallel processing, the GPU 200 by itself sets the stop information area INT1 to a “stop request” state at step S396. In the meantime, when the stop information area INT1 is not present in an area which is accessible by the GPU 200, the GPU 200 may transfer the stop request to the management thread and the stop information area INT1 may be set by the management thread.

At step S320, the GPU 200 executes a stop processing which stops the data processing DP1 being executed and issues the stop information to the CPU 100 indicating that the data processing DP1 is stopped. Accordingly, the GPU 200 does not execute an erroneous parallel processing to generate an erroneous result. Therefore, even when the data processing DP1 is made to be processed by the CPU 100 and the GPU 200, the reliability of the result obtained by the data processing DP1 may be enhanced.

At step S394, when it is determined that the parallel processing of the program executing the data processing DP1 is possible, the processing of step S396 may not be executed. In this case, for example, the stop information area INT1 may be set based on completing of the data processing DP1 by the processing thread, and the processes that are the same or similar to the processed of FIG. 7 and FIG. 8 may be executed. Otherwise, the data processing DP1 which is being executed by the processing thread may be stopped based on completing of the data processing DP1 by the GPU 200, and the processes that are the same or similar to the processes of FIG. 9 and FIG. 10 may be executed.

As described above, also in this embodiment as in the embodiments illustrated in FIG. 1 to FIG. 13, the result of the arithmetic processing apparatus which has completed the data processing first may actually be used in the data processing where it is unable to determine which one of the sequential processing and the parallel processing has been completed first and thus, the processing efficiency of the information processing apparatus may be enhanced. That is, the data processing may be executed with a high speed without analyzing the data processing times of the CPU 100 and the GPU 200 in advance as compared to conventional techniques.

Further, the GPU 200 executes a parallelism analysis which determines whether the parallel processing of the program executing the data processing DP1 may be possible and thus, an erroneous parallel processing that generates an erroneous result may be prevented. As a result, even when the CPU 100 and the GPU 200 are allowed to compete for the data processing DP1, the reliability obtained by the data processing DP1 may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A computer-readable storage medium storing a control program for controlling an information processing apparatus including a first arithmetic processing apparatus, a second arithmetic processing apparatus and a control unit that controls the first arithmetic processing apparatus and the second arithmetic processing apparatus, wherein the control program, when executed by a computer, controls the control unit to perform:
causing each of the first arithmetic processing apparatus and the second arithmetic processing apparatus to execute a first data processing common for the first and the second arithmetic processing apparatuses; and
causing the second arithmetic processing apparatus to stop the first data processing when the first data processing executed by the first arithmetic processing apparatus is completed earlier than the first data processing executed by the second arithmetic processing apparatus.

2. The computer-readable storage medium according to claim 1, wherein the control program, when executed by a computer, further controls the control unit to perform:
causing the first arithmetic processing apparatus to transfer a result obtained by the first data processing executed by the first arithmetic processing apparatus to the second arithmetic processing apparatus;
causing the first and the second arithmetic processing apparatuses to execute a second data processing common to the first and the second arithmetic processing apparatuses using the result obtained by the first data processing executed by the first arithmetic processing apparatus; and
causing the other arithmetic processing apparatus to stop the second data processing when the second data processing executed by one of the first and the second arithmetic processing apparatuses is completed earlier than the second data processing executed by the other of the first and the second arithmetic processing apparatuses.

3. The computer-readable storage medium according to claim 1, wherein the control program, when executed by a computer, further controls the control unit to perform:
causing the first arithmetic processing apparatus to execute a second data processing using the result obtained by the first data processing executed by the first arithmetic processing apparatus;
causing the first arithmetic processing apparatus to transfer a result obtained by the second data processing executed by the first arithmetic processing apparatus to the second arithmetic processing apparatus;
causing each of the first and the second arithmetic processing apparatuses to start a third data processing common to the first and the second arithmetic processing apparatuses using the result obtained by the second data processing executed by the first arithmetic processing apparatus; and
causing the other of the first and the second arithmetic processing apparatuses to stop the third data processing when the third data processing executed by one of the first and the second arithmetic processing apparatuses is completed earlier than the third data processing executed by the other of the first and the second arithmetic processing apparatuses.

4. The computer-readable storage medium according to claim 1, wherein the control program, when executed by a computer, further controls the control unit to perform:
causing each of the first and the second arithmetic processing apparatuses to execute a second data processing common to the first and the second arithmetic processing apparatuses using the result obtained by the first data processing executed by the first and the second arithmetic processing apparatuses when the first data processing executed by the first and the second arithmetic processing apparatuses is completed together within a predetermined time period; and
causing the other of the first and the second arithmetic processing apparatuses to stop the second data processing when the second data processing executed by one of the first and the second arithmetic processing apparatuses is completed earlier than the second data processing executed by the other of the first and the second arithmetic processing apparatuses.

5. The computer-readable storage medium according to claim 4, wherein the control program, when executed by a computer, further controls the control unit to perform:
causing one of the first and the second arithmetic processing apparatuses to transfer the result obtained by the second data processing executed by one of the first and the second arithmetic processing apparatuses to the other of the first and the second arithmetic processing apparatuses;
causing the first and the second arithmetic processing apparatuses to start a third data processing common to the first and the second arithmetic processing apparatuses using the result obtained by the second data processing executed by one of the first and the second arithmetic processing apparatuses; and
causing the other of the first and the second arithmetic processing apparatuses to stop the third data processing when the third data processing executed by one of the first and the second arithmetic processing apparatuses is completed earlier than the third data processing executed by the other of the first and the second arithmetic processing apparatuses.

6. The computer-readable storage medium according to claim 1, wherein the control program, when executed by a computer, further controls the control unit to perform:
causing one of the first and the second arithmetic processing apparatuses to execute a data processing by a sequential processing; and
causing the other of the first and the second arithmetic processing apparatuses to execute a data processing by a parallel processing.

7. The computer-readable storage medium according to claim 6, wherein the control program, when executed by a computer, further controls the control unit to perform:
causing the other of the first and the second arithmetic processing apparatuses to execute analyzing of whether a correct result may be obtained by the parallel processing; and
causing the other of the first and the second arithmetic processing apparatuses to stop the first data processing irrespectively of whether the first data processing executed by one of the first and the second arithmetic processing apparatuses is completed when it is determined by the analyzing that the correct result cannot be obtained.

8. A control method of an information processing apparatus including a first arithmetic processing apparatus, a second arithmetic processing apparatus and a control unit that controls the first arithmetic processing apparatus and the second arithmetic processing apparatus, wherein the control unit performs:
causing each of the first arithmetic processing apparatus and the second arithmetic processing apparatus to execute a first data processing common for the first and the second arithmetic processing apparatuses; and
causing the second arithmetic processing apparatus to stop the first data processing when the first data processing executed by the first arithmetic processing apparatus is completed earlier than the first data processing executed by the second arithmetic processing apparatus.

9. An information processing apparatus comprising:
a first arithmetic processing apparatus;
a second arithmetic processing apparatus; and
a control unit that controls the first arithmetic apparatus and the second arithmetic apparatus,
wherein
the control unit causes each of the first arithmetic processing apparatus and the second arithmetic processing apparatus to execute a first data processing common to the first and the second arithmetic processing apparatuses, and
the control unit causes the second arithmetic processing apparatus to stop the first data processing when the first data processing executed by the first arithmetic processing apparatus is completed earlier than the first data processing executed by the second arithmetic processing apparatus.
